(19) United States
(12) Patent Application Publication
(10) Pub. No.: US 2023/0313355 A1
(43) Pub. Date: Oct. 5, 2023

(54) METHOD OF PREDICTING HYDROGEN CONTENT IN STEEL OF STEEL STRIP, METHOD OF CONTROLLING HYDROGEN CONTENT IN STEEL, MANUFACTURING METHOD, METHOD OF FORMING PREDICTION MODEL OF HYDROGEN CONTENT IN STEEL, AND DEVICE THAT PREDICTS HYDROGEN CONTENT IN STEEL

(71) Applicant: JFE STEEL CORPORATION, Chiyoda-ku, Tokyo (JP)

(72) Inventors: Maiko HIYAMA, Chiyoda-ku, Tokyo (JP); Hideyuki TAKAHASHI, Chiyoda-ku, Tokyo (JP); Soshi YOSHIMOTO, Chiyoda-ku, Tokyo (JP)

(73) Assignee: JFE STEEL CORPORATION, Chiyoda-ku, Tokyo (JP)

(21) Appl. No.: 18/041,695

(22) PCT Filed: Jun. 15, 2021
(86) PCT No.: PCT/JP2021/022749

§ 371 Date: Feb. 15, 2023

(30) Foreign Application Priority Data
Sep. 3, 2020 (JP) 2020-148466
Sep. 3, 2020 (JP) 2020-148469

(51) Int. Cl. C23C 2/06; C23C 2/00

(52) U.S. Cl. CPC C23C 2/06; C23C 2/51

(57) ABSTRACT

Provided are a method of predicting hydrogen content in steel of a steel strip etc. Provided is, in a continuous galvanizing line that performs manufacturing processes including an annealing process, a coating process, and a reheating process of a steel strip, a method of predicting hydrogen content in steel of a steel strip downstream of the reheating process, including acquiring at least one parameter selected from operation parameters of the continuous galvanizing line and transformation rate information measured in at least one of the annealing process and the reheating process as input data, and predicting hydrogen content in steel of a steel strip downstream of the reheating process using a prediction model of hydrogen content in steel that has been trained by machine learning and that outputs information on hydrogen content in steel of a steel strip downstream of the reheating process as output data.

### TECHNICAL FIELD

This disclosure relates to a method of predicting hydrogen content in steel of a steel strip, a method of controlling hydrogen content in steel, a manufacturing method, a method of forming a prediction model of hydrogen content in steel, and a device that predicts hydrogen content in steel.

### BACKGROUND

In recent years, the application of high-strength steel sheets has been expanding in the automotive field to reduce the weight of automotive bodies to improve the fuel efficiency and ensure the crashworthiness of automobiles.

In particular, hot-dip galvanized steel sheets are often used for components that require rust resistance. However, there is room for improvement in terms of hydrogen embrittlement cracking in high-strength hot-dip galvanized steel sheets and high-strength cold-rolled steel sheets.

Hydrogen embrittlement cracking refers to a fracture phenomenon caused by a decrease in toughness due to absorption of hydrogen in a steel sheet. This usually refers to a phenomenon where, when stress is applied to a steel material, hydrogen enters the steel due to corrosion or other causes, and a sudden fracture occurs after a certain period of time (which is also called delayed fracture). Especially for a high-strength steel sheet, because it has a high yield stress, the residual stress caused by secondary processing such as press working also increase, which is considered as one reason why hydrogen tends to enter the steel.

In a continuous galvanizing line, which manufactures hot-dip galvanized steel sheets, and in a continuous annealing line, which manufactures cold-rolled steel sheets, heat treatment is performed in an atmosphere containing hydrogen. This allows hydrogen to once enter the inside of a steel strip during the heat treatment process. Normally, hydrogen is removed from steel by holding the steel in a temperature range of 400° C. or lower for a certain period of time. However, if the hydrogen content in steel is not sufficiently reduced on the delivery side of the continuous galvanizing line and the continuous annealing line, delayed fracture may occur in the above-described environment.

With this respect, JP 6631765 B (PTL 1) describes a treatment method as a method of manufacturing a steel sheet with a tensile strength of 1470 MPa or more, where the treatment method includes manufacturing processes of an annealing process of performing heat treatment in a predetermined temperature range for a predetermined time, then a first holding process of performing heat treatment in a predetermined temperature range for a predetermined holding time, and a second holding process of immersing a steel strip in a coating bath and then holding the steel strip in a temperature range of 330° C. to 430° C. for a predetermined time. Here, it is indicated that the hydrogen concentration inside a furnace is controlled within a predetermined range during the annealing process, the first holding process, and the second holding process, thereby controlling the hydrogen content in steel to 0.40 ppm or less.

Further, JP 6673534 B (PTL 2) describes a method of controlling the manufacturing conditions in a steel casting process and a cold rolling process to predetermined conditions, then performing an annealing process, then performing a pretreatment process of pickling, and then reheating the steel to a predetermined temperature range before performing coating treatment. It also describes a manufacturing method including a post-treatment process in which, after the coating process, the steel is heated in an atmosphere controlled to a predetermined hydrogen concentration and dew point at a temperature range of 50° C. to 400° C. for 30 seconds or longer, thereby reducing the hydrogen content in steel.

### Patent Literature

PTL 1: JP 6631765 B

PTL 2: JP 6673534 B

### CITATION LIST

### SUMMARY

### Technical Problem

The method described in PTL 1 relates to a steel sheet that has a specific chemical system and has a tensile strength of 1470 MPa or more, and PTL 1 describes that the temperature, holding time, and hydrogen concentration in the annealing process, the first holding process, and the second holding process are each specifically controlled. However, it cannot be applied to steel sheets of other strength levels. Although the steel sheet described in PTL 1 includes a plurality of phases in the internal microstructure, PTL 1 does not describe the relationship between the internal microstructure of a steel strip and the hydrogen content in steel and does not directly predict the hydrogen content in steel of a steel strip.

The method described in PTL 2 requires a combination of manufacturing conditions in a plurality of manufacturing processes, and a steel strip after the annealing process should be cooled to room temperature once, reheated, and then subjected to coating treatment, so there is room for improvement in terms of production efficiency. Further, the method described in PTL 2 does not directly predict the hydrogen content in steel of a steel strip. Moreover, the method described in PTL 2 is intended for hot-dip galvanized steel sheets and not for cold-rolled steel sheets.

To solve the above problems, it could be helpful to provide a method of predicting hydrogen content in steel of a steel strip that predicts hydrogen content in steel of a steel strip with high accuracy, a method of forming a prediction model of hydrogen content in steel, and a device that predicts hydrogen content in steel. It also could be helpful to provide a method of controlling hydrogen content in steel of a steel strip and a manufacturing method that effectively reduce the hydrogen content in steel using the method of predicting hydrogen content in steel.

### Solution to Problem

A method of predicting hydrogen content in steel of a steel strip according to one embodiment of this disclosure is
in a continuous galvanizing line that performs manufacturing processes including an annealing process, a coating process, and a reheating process of a steel strip, a method of predicting hydrogen content in steel of a steel strip downstream of the reheating process, which includes
acquiring at least one parameter selected from operation parameters of the continuous galvanizing line and transformation rate information measured in at least one of the annealing process and the reheating process as input data, and
predicting hydrogen content in steel of a steel strip downstream of the reheating process using a prediction model of hydrogen content in steel that has been trained by machine learning and that outputs information on hydrogen content in steel of a steel strip downstream of the reheating process as output data.

A method of controlling hydrogen content in steel of a steel strip according to one embodiment of this disclosure includes
predicting hydrogen content in steel of a steel strip downstream of the reheating process using the method of predicting hydrogen content in steel of a steel strip described above, and, when a predicted hydrogen content in steel exceeds a preset upper limit, resetting at least one operation parameter selected from operation parameters of the continuous galvanizing line so that hydrogen content in steel is equal to or lower than the upper limit.

A method of manufacturing a steel strip according to one embodiment of this disclosure is
a method of manufacturing a steel strip in a continuous galvanizing line that performs manufacturing processes including an annealing process, a coating process, and a reheating process of a steel strip, which includes
acquiring at least one parameter selected from operation parameters of the continuous galvanizing line and transformation rate information measured in at least one of the annealing process and the reheating process as input data,
predicting hydrogen content in steel of a steel strip downstream of the reheating process using a prediction model of hydrogen content in steel that has been trained by machine learning and that outputs information on hydrogen content in steel of a steel strip downstream of the reheating process as output data, and
when a predicted hydrogen content in steel exceeds a preset upper limit, resetting at least one operation parameter selected from operation parameters of the continuous galvanizing line so that hydrogen content in steel is equal to or lower than the upper limit.

A method of forming a prediction model of hydrogen content in steel of a steel strip according to one embodiment of this disclosure is
in a continuous galvanizing line that performs manufacturing processes including an annealing process, a coating process, and a reheating process of a steel strip, a method of forming a prediction model of hydrogen content in steel of a steel strip that predicts hydrogen content in steel of a steel strip downstream of the reheating process, which includes
at least acquiring at least one operational performance data selected from operational performance data of the continuous galvanizing line and performance data of transformation rate information measured in at least one of the annealing process and the reheating process as input performance data,
acquiring a plurality of training data, in which information on hydrogen content in steel of a steel strip downstream of the reheating process based on the input performance data is used as output performance data, and
forming a prediction model of hydrogen content in steel of a steel strip by machine learning using the acquired plurality of training data.

A device that predicts hydrogen content in steel of a steel strip according to one embodiment of this disclosure is
in a continuous galvanizing line that performs manufacturing processes including an annealing process, a coating process, and a reheating process of a steel strip, a device that predicts hydrogen content in steel that predicts hydrogen content in steel of a steel strip downstream of the reheating process, which includes
an acquisition unit that acquires at least one parameter selected from operation parameters of the continuous galvanizing line and transformation rate information measured in at least one of the annealing process and the reheating process, and
a prediction unit that predicts hydrogen content in steel of a steel strip downstream of the reheating process using a prediction model of hydrogen content in steel that has been trained by machine learning and that outputs information on hydrogen content in steel of a steel strip downstream of the reheating process as output data.

A method of predicting hydrogen content in steel of a steel strip according to one embodiment of this disclosure is
in a continuous annealing line that performs manufacturing processes including an annealing process and a reheating process of a steel strip, a method of predicting hydrogen content in steel of a steel strip downstream of the reheating process, which includes
acquiring at least one parameter selected from operation parameters of the continuous annealing line and transformation rate information measured in at least one of the annealing process and the reheating process as input data, and
predicting hydrogen content in steel of a steel strip downstream of the reheating process using a prediction model of hydrogen content in steel that has been trained by machine learning and that outputs information on hydrogen content in steel of a steel strip downstream of the reheating process as output data.

A method of controlling hydrogen content in steel of a steel strip according to one embodiment of this disclosure includes
predicting hydrogen content in steel of a steel strip downstream of the reheating process using the method of predicting hydrogen content in steel of a steel strip described above, and, when a predicted hydrogen content in steel exceeds a preset upper limit, resetting at least one operation parameter selected from operation parameters of the continuous annealing line so that hydrogen content in steel is equal to or lower than the upper limit.

A method of manufacturing a steel strip according to one embodiment of this disclosure is
a method of manufacturing a steel strip in a continuous annealing line that performs manufacturing processes including an annealing process and a reheating process of a steel strip, which includes
acquiring at least one parameter selected from operation parameters of the continuous annealing line and transformation rate information measured in
at least one of the annealing process and the reheating process as input data, predicting hydrogen content in steel of a steel strip downstream of the reheating process using a prediction model of hydrogen content in steel that has been trained by machine learning and that outputs information on hydrogen content in steel of a steel strip downstream of the reheating process as output data, and
when a predicted hydrogen content in steel exceeds a preset upper limit, resetting at least one operation parameter selected from operation parameters of the continuous annealing line so that hydrogen content in steel is equal to or lower than the upper limit.

A method of forming a prediction model of hydrogen content in steel of a steel strip according to one embodiment of this disclosure is
in a continuous annealing line that performs manufacturing processes including an annealing process and a reheating process of a steel strip, a method of forming a prediction model of hydrogen content in steel of a steel strip that predicts hydrogen content in steel of a steel strip downstream of the reheating process, which includes
at least acquiring at least one operational performance data selected from operational performance data of the continuous annealing line and performance data of transformation rate information measured in at least one of the annealing process and the reheating process as input performance data,
acquiring a plurality of training data, in which information on hydrogen content in steel of a steel strip downstream of the reheating process based on the input performance data is used as output performance data, and forming a prediction model of hydrogen content in steel of a steel strip by machine learning using the acquired plurality of training data.

A device that predicts hydrogen content in steel of a steel strip according to one embodiment of this disclosure is
in a continuous annealing line that performs manufacturing processes including an annealing process and a reheating process of a steel strip, a device that predicts hydrogen content in steel that predicts hydrogen content in steel of a steel strip downstream of the reheating process, which includes
an acquisition unit that acquires at least one parameter selected from operation parameters of the continuous annealing line and transformation rate information measured in at least one of the annealing process and the reheating process, and
a prediction unit that predicts hydrogen content in steel of a steel strip downstream of the reheating process using a prediction model of hydrogen content in steel that has been trained by machine learning and that outputs information on hydrogen content in steel of a steel strip downstream of the reheating process as output data.

### Advantageous Effect

According to this disclosure, it is possible to provide a method of predicting hydrogen content in steel of a steel strip that predicts hydrogen content in steel of a steel strip with high accuracy, a method of forming a prediction model of hydrogen content in steel, and a device that predicts hydrogen content in steel. According to this disclosure, it is possible to provide a method of controlling hydrogen content in steel of a steel strip and a manufacturing method that effectively reduce the hydrogen content in steel using the method of predicting hydrogen content in steel.

### BRIEF DESCRIPTION OF THE DRAWINGS

In the accompanying drawings:

FIG. 1 illustrates a galvanizing line used to manufacture galvanized steel sheets, which is an example of a continuous galvanizing line;

FIG. 2 illustrates an example of the thermal history in a galvanizing line used to manufacture galvanized steel sheets;

FIG. 3 illustrates a method of forming a prediction model of hydrogen content in steel;

FIG. 4 illustrates a method of controlling hydrogen content in steel;

FIG. 5 explains a device that predicts hydrogen content in steel;

FIG. 6 illustrates a continuous annealing line used to manufacture cold-rolled steel sheets, which is an example of a continuous annealing line;

FIG. 7 illustrates an example of the thermal history in a continuous annealing line used to manufacture cold-rolled steel sheets;

FIG. 8 illustrates a method of forming a prediction model of hydrogen content in steel; and

FIG. 9 illustrates a method of controlling hydrogen content in steel.

### DETAILED DESCRIPTION

### First Embodiment

A method of predicting hydrogen content in steel of a steel strip of a first embodiment of this disclosure predicts the hydrogen content in steel of a hot-dip galvanized steel sheet at the delivery side of a continuous galvanizing line, where the hot-dip galvanized steel sheet is manufactured by subjecting a steel sheet, whose thickness has been reduced to a specified value through a hot rolling process, a pickling process, and a cold rolling process, to heat treatment and coating treatment by a continuous galvanizing line. The cold rolling process may be omitted. The thin steel sheet is coiled and then subjected to heat treatment and the like at least after the hot rolling process. Therefore, the thin steel sheet may be referred to as “steel strip” in this embodiment.

### Continuous Galvanizing Line

In this embodiment, the continuous galvanizing line refers to a continuous galvanizing line (CGL) that performs manufacturing processes including an annealing process, a coating process, and a reheating process. The following describes the continuous galvanizing line in detail with reference to the drawings.

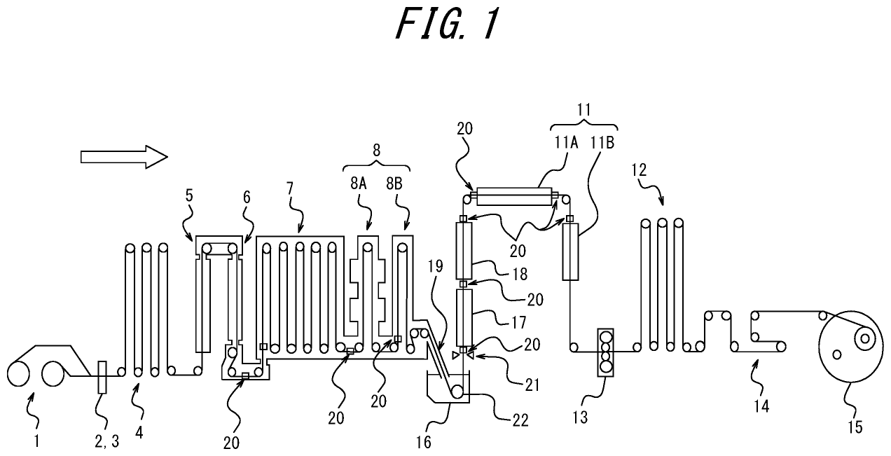

FIG. 1 schematically illustrates an example of a continuous galvanizing line used to manufacture hot-dip galvanized steel sheets. The arrow in FIG. 1 indicates the travel direction of a steel strip. The continuous galvanizing line is roughly divided into entry-side equipment, a furnace section, and delivery-side equipment. The entry-side equipment includes a payoff reel 1, a welder 2, an electrolytic cleaning device 3, and an entry-side looper 4. The furnace section includes an annealing section, a coating section, and a reheating section. The delivery-side equipment includes a delivery-side looper 12, a temper rolling system 13, an inspection system 14, and a tension reel 15. The inspection system 14 has a sample collection system that collects a sample material from the steel strip for offline measurement of hydrogen content in steel.

The annealing section has a heating zone 6, a soaking zone 7, and a cooling zone 8, and it may have a preheating zone 5 upstream of the heating zone 6. The annealing process in this embodiment is a heat treatment process performed in the annealing section. More specifically, the annealing process is a process of heating the steel strip from around room temperature, holding the steel strip at a predetermined temperature, and then lowering the temperature of the steel strip to a temperature suitable for galvanizing. The continuous galvanizing line has a coating section downstream of the annealing section, where the steel strip that has been cooled to a predetermined temperature in the cooling zone 8 is immersed into a zinc pot, and the coating amount of zinc (coating weight) is adjusted by a wiping device 21. The coating process in this embodiment is a galvanizing treatment process performed in the coating section. The reheating section downstream of this section includes an alloying zone 17, a holding zone 18, and a final cooling zone 11, where the alloying zone 17 is equipped with an induction heating device. The reheating process in this embodiment is a heat treatment process performed in the reheating section.

The heating zone 6 is a system for raising the temperature of the steel strip, and it heats the steel strip to a preset temperature in a range of about 700° C. to 900° C. depending on the type of the steel. In the heating zone 6, direct fire or a radiant combustion burner is used. The soaking zone 7 is a system that maintains the steel strip at a predetermined temperature, and it has a heating capacity sufficient to compensate for heat dissipation from the furnace body and the like. The cooling zone 8 is a system that cools the steel strip down to about 480° C., which is a suitable temperature for galvanizing, and it commonly uses gas jet cooling as a cooling means. In this case, the thermal history during cooling of the steel strip can be controlled by dividing the cooling zone 8 into a plurality of zones such as a first cooling zone 8A and a second cooling zone 8B and changing the cooling conditions.

A mixed gas containing hydrogen, nitrogen, and water vapor is supplied inside each of the heating zone 6, the soaking zone 7, and the cooling zone 8 to adjust the atmosphere during the annealing process. Since the supplied gas contains water vapor, not only the gas composition but also the dew point of the atmosphere during the annealing process is adjusted.

The coating section includes a snout 19 connected to the outlet of the cooling zone 8, a galvanizing tank 16, and a wiping device 21. The snout 19 is a member with a rectangular cross section that defines a space through which the steel strip passes. A mixed gas containing hydrogen, nitrogen, and water vapor is supplied to the inside of the snout 19, and the atmosphere gas is adjusted until the steel strip is immersed in the galvanizing tank 16. The galvanizing tank 16 has a sink roll 22 inside. The sink roll 22 is a system for immersing the steel strip that has passed through the snout 19 downward into the galvanizing tank 16 and lifting the steel strip with molten zinc adhering its surface above the coating bath. Further, the wiping device 21 is a system in which a wiping gas is blown from nozzles arranged on both sides of the steel strip to scrape off surplus molten zinc adhering to the surface of the steel strip, thereby adjusting the coating amount of molten zinc.

A reheating zone (called alloying zone 17) of the reheating section is arranged further above (on the downstream side of) the wiping device 21 of the coating section. Normally, the temperature of the steel strip that has passed through the wiping device 21 drops to about 430° C. Therefore, the steel strip is heated in the alloying zone 17 to a temperature at which a Zn-Fe alloying reaction proceeds. The temperature to be raised to in the alloying zone 17 corresponds to the target alloying temperature, and it varies depending on the alloy composition of the steel sheet, the Al concentration in the coating bath, and the like. Usually, the temperature is raised to about 500° C. After that, the temperature of the steel strip is maintained in the holding zone 18 to secure the time necessary for the alloying reaction to proceed. Downstream of the holding zone 18 is the final cooling zone 11, which is a system for final cooling of the steel strip that has undergone alloying treatment to around room temperature. As with the cooling zone 8, the final cooling zone 11 may be divided into a plurality of zones such as a first final cooling zone 11A and a second final cooling zone 11B to control the thermal history during cooling of the steel strip.

In the continuous galvanizing line, thermometers are installed at a plurality of positions to measure the surface temperature of the steel strip in the heating zone 6, the soaking zone 7, and the cooling zone 8 of the annealing section, and the alloying zone 17, the holding zone 18, and the final cooling zone 11 of the reheating process. Further, furnace thermometers are installed to measure not only the surface temperature of the steel strip but also the atmosphere temperature inside the furnace in each zone of the annealing process and the reheating process. The measured surface temperature of the steel strip and the atmosphere temperature are output to a process computer that controls the continuous galvanizing line and supervises the operation.

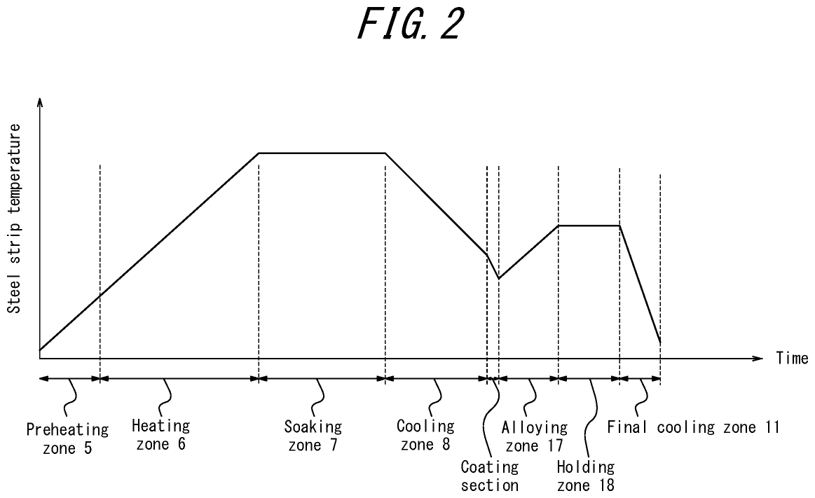

FIG. 2 is a graph illustrating the thermal history of the steel strip in the continuous galvanizing line used to manufacture hot-dip galvanized steel sheets, including the annealing process and the reheating process. The horizontal axis indicates time, and the vertical axis indicates steel strip temperature. The steel strip temperature is, for example, the surface temperature of the steel strip. It illustrates the thermal history of the steel strip that has undergone an annealing process by the heating zone 6, the soaking zone 7, and the cooling zone 8, and then passed through the coating section, and undergone a reheating process by the alloying zone 17, the holding zone 18, and the final cooling zone 11. To prevent variations in material properties depending on the longitudinal position of the steel strip, the transport speed of the steel strip is kept constant during the annealing process. However, when steel strips with different thicknesses, widths, steel grades, etc. are welded together, the line speed may change before and after the welded portion. Therefore, the shape of the graph of the thermal history may vary depending on the measurement position of the steel strip. Depending on the operating conditions, the reheating process by the alloying zone 17, the holding zone 18, and the final cooling zone 11 may not be performed. In such a case, the temperature of the steel strip that has passed through the coating section is about room temperature and has a substantially constant thermal history.

### Control of Atmosphere Gas

A mixed gas containing hydrogen, nitrogen, and water vapor is supplied inside each of the heating zone 6, the soaking zone 7, and the cooling zone 8, by which the annealing process is performed, to control the atmosphere of the annealing process. Since hydrogen contained in the atmosphere of the annealing process affects the amount of hydrogen that enters the steel strip during the annealing process, the composition and the flow rate of the input gas are measured, and adjusted and controlled as necessary.

In the heating zone 6, the steel strip can be heated indirectly using a heating device such as a radiant tube (RT) or an electric heater. The heating zone 6 may be supplied with a reducing gas or a non-oxidizing gas while the gases from the soaking zone 7, the cooling zone 8, and the snout 19 flowing into the heating zone 6. A H₂—N₂ mixed gas is usually used as the reducing gas. Examples of such a H₂—N₂ mixed gas include a gas (dew point: about −60° C.) having a composition of 1% by volume to 20% by volume of H₂, with the balance being N₂ and inevitable impurities. Further, a gas (dew point: about −60° C.) having a composition of N₂ and inevitable impurities is used as the non-oxidizing gas. A method of supplying the gas to the heating zone 6 is not limited, but it is preferable to supply the gas from at least two supply ports in the height direction and at least one supply port in the longitudinal direction so that the gas is uniformly introduced into the heating zone 6.

In the soaking zone 7, the steel strip may be heated indirectly using a radiant tube as a heating means. The average temperature inside the soaking zone 7 is preferably 700° C. to 900° C. A reducing gas or a non-oxidizing gas is supplied to the soaking zone 7. A H₂—N₂ mixed gas is usually used as the reducing gas, and examples thereof include a gas (dew point: about −60° C.) having a composition of 1% by volume to 20% by volume of H₂, with the balance being N₂ and inevitable impurities. Further, examples of the non-oxidizing gas include a gas (dew point: about −60° C.) having a composition of N₂ and inevitable impurities.

The cooling zone 8 is equipped with a cooling device, and the steel strip is cooled when it passes through the cooling zone 8. The cooling zone 8 can also be supplied with the above-described gas, as in the soaking zone 7. It is preferable to supply the gas from at least two supply ports in the height direction and at least two supply ports in the longitudinal direction of the cooling zone 8 so that the gas is uniformly introduced into the cooling zone 8.

A hydrogen concentration meter and a dew point meter for measuring the gas atmosphere inside the furnace are installed in the heating zone 6, the soaking zone 7, and the cooling zone 8 in which the annealing process is performed. The hydrogen concentration meter uses a contact combustion type sensor that measures the rising temperature of a platinum wire coil due to the contact combustion of gas on the surface of a catalyst. For example, a combustible gas detector XP-3110 manufactured by NEW COSMOS ELECTRIC CO., LTD. can be used. However, hydrogen concentration meters based on other measurement methods may be used, such as one that detects the hydrogen concentration based on changes in thermal conductivity depending on the gas concentration. A capacitance-type dew point meter or a mirror surface cooling-type dew point meter may be used. For example, a DMT345 dew point transducer manufactured by VAISALA may be used.

It is preferable to install the hydrogen concentration meter in any of the heating zone 6, the soaking zone 7, and the cooling zone 8. The hydrogen concentration meter may be installed at any position in the heating zone 6, the soaking zone 7, and the cooling zone 8. However, since hydrogen in steel diffuses more easily as the temperature of the steel strip increases, it is preferable to install the hydrogen concentration meter near the delivery side of the heating zone 6 or in the soaking zone 7. The hydrogen concentration meter may be installed at any one position, but it is preferable to install a plurality of hydrogen concentration meters at different positions. This is because acquiring a plurality of pieces of hydrogen concentration information improves the prediction accuracy of the hydrogen content in steel. The measured values are output to the process computer.

The same applies to the dew point meter, where it is preferable to install the dew point meter in any of the heating zone 6, the soaking zone 7, and the cooling zone 8. The dew point meter may be installed at any position in the heating zone 6, the soaking zone 7, and the cooling zone 8. The dew point meter may be installed at any one position, but it is preferable to install a plurality of dew point meters at different positions. This is because acquiring a plurality of pieces of dew point information improves the prediction accuracy of the hydrogen content in steel. The measured values are output to the process computer.

A mixed gas containing hydrogen, nitrogen, and water vapor is supplied inside the snout 19 of the coating section to control the atmosphere. Since hydrogen contained in the atmosphere affects the amount of hydrogen that enters the steel strip inside the snout 19, the composition and flow rate of the input gas are measured, and adjusted and controlled as necessary.

The snout 19 is also equipped with a hydrogen concentration meter and a dew point meter to measure the gas atmosphere inside the snout 19. The hydrogen concentration meter and the dew point meter may be installed at any position. One hydrogen concentration meter and one dew point meter may be installed, respectively. However, it is preferable to install a plurality of hydrogen concentration meters and dew point meters at different positions. This is because acquiring a plurality of pieces of hydrogen concentration information and dew point information improves the prediction accuracy of the hydrogen content in steel. The measured values are output to the process computer.

Inside each zone of the reheating process, a mixed gas containing hydrogen, nitrogen, and water vapor is supplied to control the atmosphere. Since hydrogen contained in the atmosphere affects the amount of hydrogen that enters the steel strip in the reheating process, the composition and flow rate of the input gas are measured, and adjusted and controlled as necessary.

In the reheating process, a hydrogen concentration meter and a dew point meter are also installed to measure the gas atmosphere. The hydrogen concentration meter and the dew point meter may be installed at any position.

One hydrogen concentration meter and one dew point meter may be installed, respectively. However, it is preferable to install a plurality of hydrogen concentration meters and dew point meters at different positions. This is because acquiring a plurality of pieces of hydrogen concentration meter information and dew point information improves the prediction accuracy of the hydrogen content in steel. The measured values are output to the process computer.

### Transformation Rate Meter

A transformation rate meter 20 is a meter that measures a ratio of austenite phase (γ phase) to the whole internal microstructure of the steel strip in the heat treatment process. In the continuous galvanizing line, the microstructure of a steel sheet is often controlled using phase transformation from a specific two-phase state of austenite phase (γ phase) and ferrite phase (α phase). Therefore, the transformation rate meter 20 may be a transformation rate meter 20 that uses X-ray diffraction. Because the crystal structures of the γ phase and the α phase are different, each produces diffraction peaks at unique angles when exposed to X-rays. This is a method of quantifying the transformation rate (γ rate) based on the diffraction peak intensity. For example, a product called X-CAP, which is manufactured by SMS, may be used. Further, a method of measuring the austenite phase rate using a magnetic transformation rate measuring device may be used, where the magnetic transformation rate measuring device includes a driving coil that forms a magnetic field and a detection coil that measures the magnetic field through which the steel strip is passed, and the magnetic transformation rate measuring device is used as a magnetic detector, i.e. a device that measures the magnetic transformation rate of the steel strip. Specifically, the device described in JP 2019-7907 A may be used.

In this embodiment, such a transformation rate meter 20 that measures the austenite phase rate is installed in at least one of the annealing process or the reheating process of the continuous galvanizing line. For example, the transformation rate meters 20 in FIG. 1 indicate candidate positions for installation. The positions for installation are, for example, at the inlet of soaking zone 7, at the outlet of the soaking zone 7, and at the inlet of the cooling zone 8 in the annealing process, and it is preferably installed at the inlet or outlet of the alloying zone 17 in the reheating process. The transformation rate meter 20 may be installed at any one position, but it is preferable to install a plurality of transformation rate meters 20 at different positions. This is because acquiring a plurality of pieces of transformation rate information improves the prediction accuracy of the hydrogen content in steel.

### Information on Hydrogen Content in Steel of Steel Strip

The information on the hydrogen content in steel is a value of diffusible hydrogen content obtained by collecting a test piece from a sample material of the steel strip collected in the sample collection system of the hot-dip galvanizing line and measuring the sample material by an off-line device for measuring the hydrogen content in steel. The device for measuring the hydrogen content in steel may be any measuring device that can measure the amount of hydrogen contained in steel in a range of 0.01 ppm to 10 ppm. Specifically, a measuring device based on a temperature rise hydrogen analysis method by gas chromatograph may be used.

Examples of methods of measuring the hydrogen content include gas chromatography-mass spectrometry (GC/MS) and thermal desorption spectroscopy (TDS). Examples of the device include GC-4000 Plus of GL Sciences Inc., and TDS1200 of UBE Scientific Analysis Laboratory, Inc.

The hydrogen content in steel can be measured by thermal desorption analysis as follows. First, a test piece of about 5 mm×30 mm is cut from the coated steel sheet. The coating on the surface of the test piece is removed using a router (precision grinder), and the test piece is placed in a quartz tube. Next, after replacing the inside of the quartz tube with Ar, the temperature is raised at 200° C./hr, and hydrogen formed up to 400° C. is measured by gas chromatography. In this case, the diffusible hydrogen content in steel is the cumulative amount of hydrogen detected in the temperature range from room temperature (25° C.) to 400° C.

The information on the hydrogen content in steel of the steel strip thus obtained is sent to a host computer (a computer that gives manufacturing instructions to the process computer) together with the identification number (coil number) of the steel strip from which the test piece is collected and, if necessary, the information on the sampling position.

### Method of Forming Prediction Model of Hydrogen Content in Steel

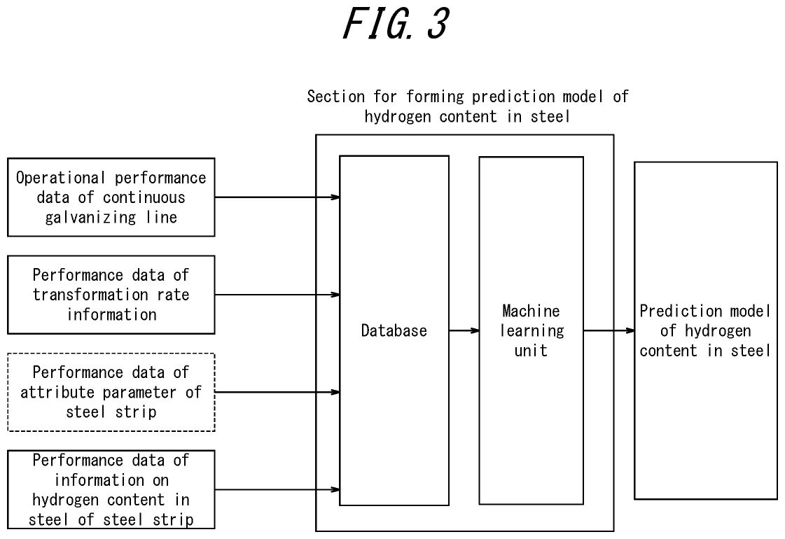

FIG. 3 illustrates a method of forming a prediction model of hydrogen content in steel of a steel strip according to this embodiment.

Operational performance data of the continuous galvanizing line, performance data of the transformation rate information of the steel strip measured by the transformation rate meter 20, and performance data of the information on the hydrogen content in steel of the steel strip are stored in a database. The details of the operational performance data of the continuous galvanizing line will be described below. Performance data selected from the operational performance data in the process computer that controls the operation of the continuous galvanizing line is sent to a database of a unit for forming a prediction model of hydrogen content in steel. The performance data of the transformation rate information of the steel strip is the transformation rate information acquired from the transformation rate meter 20, and if the transformation rate information is stored in the process computer, it is sent from the process computer to the database. However, if the transformation rate information is not stored in the process computer, it is sent directly to the database of the unit for forming a prediction model of hydrogen content in steel.

The information on the hydrogen content in steel is sent to the database together with ancillary information that can be correlated with the operational performance data of the continuous galvanizing line, such as the coil number of the steel strip. Further, the performance data of the information on the hydrogen content in steel of the steel strip is information obtained by an off-line test, and it is stored in the host computer. This information is also sent to the database together with ancillary information that can be correlated with the operational performance data of the continuous galvanizing line, such as the coil number of the steel strip. The operational performance data of the continuous galvanizing line, the performance data of the transformation rate information of the steel strip measured by the transformation rate meter 20, and the performance data of the information on the hydrogen content in steel of the steel strip are correlated with each other by the coil number or the like, and they are stored in the database as a set of data. In this case, for the sets of data stored in the database, each steel strip acquires one set of data. However, if the performance data of the information on the hydrogen content in steel of the steel strip is acquired at a plurality of positions, such as the lead end and the tail end of the steel strip, one steel strip may acquire a plurality of sets of data using the operational performance data of the continuous galvanizing line and the performance data of the transformation rate information of the steel strip acquired at the plurality of positions such as the lead end and the tail end of the steel strip.

The database preferably has at least one parameter selected from attribute parameters of the steel strip related to the chemical composition of the steel strip. The performance data of the attribute parameter of the steel strip related to the chemical composition of the steel strip is stored together with the coil number in the process computer or the host computer as the performance value in the steelmaking process, and it may be sent to the database as appropriate to constitute a set of data. By adding the attribute parameter of the steel strip related to the chemical composition of the steel strip as input, the prediction model of hydrogen content in steel in this embodiment can be widely applied to steel strips with different chemical compositions.

The number of sets of data in the database used to form a prediction model of hydrogen content in steel in this embodiment is preferably 200 or more and more preferably 1000 or more.

In this embodiment, the database thus created is used to form a prediction model of hydrogen content in steel of the steel strip, where at least one operational performance data selected from the operational performance data of the continuous galvanizing line and the performance data of the transformation rate information measured by the transformation rate meter 20 installed at one or more positions in either the annealing process or the reheating process are at least used as input performance data, and the prediction model is trained by machine learning using the input performance data.

Any known machine learning method can be applied as the machine learning method, and any machine learning model can be used as long as it provides sufficient accuracy in predicting the hydrogen content in steel of a steel sheet in practice. For example, known machine learning methods using neural networks, including deep learning, convolutional neural networks (CNN), and recurrent neural networks (RNN), may be used. Examples of other methods include decision tree learning, random forests, support vector regression, and Gaussian processes. An ensemble model combining a plurality of models may also be used. The prediction model of hydrogen content in steel may be updated as appropriate using the latest training data. In this case, it can respond to long-term changes in operating conditions of the continuous galvanizing line.

### Operation Parameter of Continuous Galvanizing Line

Any operation parameter that affects the hydrogen content in steel of the steel strip other than the transformation rate information measured by the transformation rate meter 20 can be used as an operation parameter of the continuous galvanizing line. The operation parameters in the continuous galvanizing line are roughly classified into operation parameters related to the thermal history of the steel strip and operation parameters related to the atmosphere gas of the continuous galvanizing line in which the steel strip is passed.

### Operation Parameter Related to Thermal History

Based on the example of the thermal history of a steel strip during the annealing, coating, and reheating processes illustrated in FIG. 2, operation parameters in the continuous galvanizing line as follows may be used.

For example, the time the steel strip takes to pass through the heating zone 6 and the temperature rise during the passing, or the average heating rate calculated based on these values may be used as the operation parameter of the heating zone 6.

The soaking temperature, which is the average temperature of the steel strip in the soaking zone 7, and the soaking time, which is the time to pass through the soaking zone 7, may be used as the operation parameters of the soaking zone 7. The time the steel strip takes to pass through the first cooling zone 8A and the temperature drop during the passing, or the average cooling rate calculated based on these values may be used as the operation parameters of the cooling zone 8. Further, the time the steel strip takes to pass through the second cooling zone 8B and the temperature drop during the passing, or the average cooling rate calculated based on these values may be used as the operation parameter of the cooling zone 8.

The control output value of a heating device in the heating zone 6 and the control output value of a cooling device in the cooling zone 8 may be used as the operation parameters. This is because these operation parameters are operation parameters used to control the temperature history of the steel strip during the annealing process. Further, the line speed of the steel strip in the soaking zone 7, the average cooling rate in the cooling zone 8, and the injection pressure of a cooling device such as gas injection may be used. This is because these factors also affect the thermal history of the steel strip.

The atmosphere temperature inside the snout 19, the bath temperature of the coating bath in the galvanizing tank 16, and the temperature and injection pressure of the gas injected toward the steel strip in the wiping device 21 may be used as the operation parameters in the coating section.

The temperature rise measured by radiation thermometers arranged at the entry side and the delivery side of the induction heating device installed in the alloying zone 17 and the passage time, or the average heating rate calculated based on these values may be used as the operation parameters of the alloying zone 17. The average temperature of the steel strip in the holding zone 18 and the time it takes to pass through the holding zone 18 may be used as the operation parameters of the holding zone 18. The time the steel strip takes to pass through the final cooling zone 11 and the temperature drop during the passing, or the average cooling rate calculated based on these values may be used as the operation parameters of the final cooling zone 11. Further, the control output value of a heating device in the alloying zone 17 and the control output value of a cooling device in the final cooling zone 11 may be used as the operation parameters. This is because these operation parameters are operation parameters used to control the temperature history of the steel strip during the reheating process.

### Operation Parameter Related to Atmosphere Gas

In addition to the operation parameters related the thermal history of the steel strip described above, operation parameters related to the atmosphere gas of the continuous galvanizing line in which the steel strip is passed may be selected as the operation parameters in the continuous galvanizing line according to this embodiment.

The gas composition of the atmosphere gas in each of the heating zone 6, the soaking zone 7, and the cooling zone 8 may be used as operation parameters in the annealing section. It is particularly preferable to use hydrogen concentration. This is because it affects the amount of hydrogen that enters the steel strip during the annealing process.

The coating thickness controlled by the wiping device 21 can be used as the operation parameter in the coating section. This is because, when the steel strip is galvanized, the presence of the coating prevents hydrogen that has entered the steel from escaping, but the extent of this depends on the thickness of the coating.

The gas composition of the atmosphere gas inside the snout 19 of the coating section can be used as the operation parameter inside the snout 19 of the coating section. It is particularly preferable to use hydrogen concentration. This is because it affects the amount of hydrogen that enters the steel strip inside the snout 19.

The gas composition of the atmosphere gas in each of the alloying zone 17, the holding zone 18, and the final cooling zone 11 can be used as the operation parameters in the reheating section. It is particularly preferable to use hydrogen concentration. This is because it affects the easiness of escape of hydrogen in the steel to the outside in the reheating process.

Further, the concentration of gas component inside each section changes depending on the H₂, N₂, and H₂O supplied to the inside of the snout 19 of the annealing section, the reheating section, and the coating section, thereby changing the internal dew point, that is, the H₂O concentration. Since this affects the concentration of H₂ in the atmosphere, the dew point inside the snout 19 in the annealing section, the reheating section, and the coating section may be used as the operation parameters in the continuous galvanizing line.

### Selection of Operation Parameter of Continuous Galvanizing Line

In this embodiment, at least one of the operation parameters selected from the above operation parameters of the continuous galvanizing line is input to the prediction model of hydrogen content in steel of the steel strip.

The reason for using the operation parameters related to the thermal history of the steel strip in the annealing section, the coating section, and the reheating section is that the diffusion rate of hydrogen in steel is affected by the temperature of the steel strip. Further, when the diffusion rate of hydrogen is high, hydrogen tends to penetrate from the surface of the steel strip.

The reason for using the time the steel strip takes to pass through each zone (residence time in each zone) when it passes through the annealing section, the coating section, and the reheating section as the operation parameters is that they affect the amount of hydrogen that enters the steel or the amount of hydrogen that is discharged. Further, these amounts change during diffusion time in the steel.

The hydrogen content in steel increases in the annealing section where the steel strip is kept at a high temperature, and the hydrogen content in steel decreases in the reheating section where the steel strip is kept at a relatively low temperature. Further, the easiness of escape of hydrogen from the steel is affected by the coating applied to the surface of the steel strip by the coating section. Therefore, it is preferable to use a combination of at least one parameter selected from the operation parameters of the annealing section and at least one parameter selected from the operation parameters of the reheating section as the operation parameters related to the thermal history. This is because the hydrogen content in steel of the steel strip detected at the delivery side of the continuous galvanizing line is greatly affected by the balance between the hydrogen entering the steel and the hydrogen being discharged from the steel. It is more preferable to further use at least one parameter selected from the operation parameters of the coating section in addition to these operation parameters. This is because it affects the balance between the hydrogen entering the steel and the hydrogen being discharged from the steel.

On the other hand, the reason for using the operation parameters related to the atmosphere in each zone of the annealing section, the coating section, and the reheating section is that, as described above, the composition of the atmosphere gas affects the hydrogen entering the steel and the hydrogen being discharged from the steel. Therefore, it is preferable to use a combination of at least one parameter selected from the operation parameters related to the thermal history and those selected from the operation parameters related to the atmosphere gas in this embodiment. This is because they all affect the hydrogen entering the steel and the hydrogen being discharged from the steel.

With respect to the operation parameters in the continuous galvanizing line in this embodiment, one set of operation parameters is acquired as training data for each steel strip as the operation data. This is because information on the hydrogen content in steel, which is the output of the prediction model of hydrogen content in steel, is basically collected for each steel strip. In this case, the above-described data on thermal history and data on atmosphere gas and the like are continuously collected in the longitudinal direction of the steel strip, and a representative value is calculated for one steel strip and used as the operation parameter in the continuous galvanizing line. For example, it is possible to use data collected at a preset distance from the lead end or the tail end of the steel strip, or data obtained by averaging the measured values in the longitudinal direction.

### Transformation Rate Information

In this embodiment, the transformation rate meter 20, which measures the ratio of austenite phase, is installed in at least one of the annealing process or the reheating process of the continuous galvanizing line, and the result of measurement by the transformation rate meter 20 is used as transformation rate information as one of training data for the prediction model of hydrogen content in steel.

The data acquired by the transformation rate meter 20 is continuous data acquired at each sampling cycle in the longitudinal direction of the steel strip as data of the ratio of austenite phase of the steel strip, and a representative value is calculated for one steel strip and used as performance data of transformation rate information. It is preferable to use the measurement result of the transformation rate measured at a position roughly corresponding to the position where the performance data of the information on the hydrogen content in steel of the steel strip, which is the output of the prediction model of hydrogen content in steel, is acquired as the performance data of transformation rate information. In the continuous galvanizing line, the transformation rate of the steel strip may vary in the longitudinal direction, and the correlation between the transformation rate and the hydrogen content in steel of the steel strip is relatively high. Therefore, by associating the measured value of the transformation rate with the performance data collection position of the hydrogen content in steel, it is possible to predict the hydrogen content in steel with higher accuracy.

As used herein, the ratio of austenite phase (γ phase) of the steel strip is an important parameter for predicting the hydrogen content in steel. In general, the austenite phase has a hydrogen diffusion coefficient about one digit smaller than that of the ferrite phase (α phase). Therefore, in a zone such as the soaking section of the continuous galvanizing line, in which the temperature is high and γ-phase is the main phase, the penetration of hydrogen from the surrounding atmosphere gas into the steel is slowed down, and the hydrogen that has penetrated into the steel is less likely to be released to the surroundings. On the other hand, in a zone such as the holding zone 18 where an internal microstructure with a certain amount of ferrite phase (α-phase) is formed, the penetration of hydrogen from the surrounding atmosphere gas into the steel is facilitated, and the hydrogen that has penetrated into the steel is likely to be released to the surroundings.

In the continuous galvanizing line, the mechanical properties of steel are controlled by controlling the microstructure of the steel strip using phase transformation, and the internal microstructure of the steel strip changes as the steel strip passes through each zone of the annealing section (heating zone 6, soaking zone 7, and cooling zone 8), the coating section (snout 19, galvanizing tank 16, and wiping device 21), and the reheating section (alloying zone 17, holding zone 18, and final cooling zone 11). Therefore, acquiring information on the austenite phase (γ phase) of the steel strip by the transformation rate meter 20 improves the prediction accuracy of the hydrogen content in steel of the steel strip.

The phase transformation behavior of the steel strip varies depending on the strength level and the chemical composition of the steel strip as a product, and the history of changes in the internal microstructure also changes. Therefore, when trying to predict the hydrogen content in steel for different types of steel, the significance of using the transformation rate information acquired by the transformation rate meter 20, which reflects the information on the internal microstructure of the steel strip, in the prediction model of hydrogen content in steel increases.

On the other hand, the reason for using the transformation rate information measured by the transformation rate meter 20 in addition to the operation parameters of the continuous galvanizing line in this embodiment is as follows. The operation parameters of the continuous galvanizing line affect the hydrogen content in steel of the steel strip through processes such as recovery, recrystallization, grain growth, precipitation, and phase transformation in the internal microstructure of the steel strip. However, such changes in the internal microstructure are not only determined by the operation parameters of the continuous galvanizing line, but also are affected by the processing history of the preceding hot rolling and cold rolling processes. For example, the coiling temperature in the hot rolling process affects the size (distribution) and amount of precipitate as the internal microstructure of a hot-rolled steel sheet, and it also affects the grain growth and transformation behavior in the heat treatment process. The rolling reduction during the cold rolling process affects the recrystallization, grain growth, and transformation behavior of the annealing process through the strain state accumulated in the internal microstructure of a cold-rolled steel sheet. Therefore, if only the operation parameters of the continuous galvanizing line are used as training data for the prediction model of hydrogen content in steel, the influence of the operation parameters of processes preceding the annealing process on the hydrogen content in steel of the steel strip after heat treatment is not taken into consideration. As a result, it is difficult to predict the hydrogen content in steel.

On the other hand, by using the transformation rate information measured by the transformation rate meter 20 in the heating or reheating process as the training data, the influence of the operation parameters in the hot rolling process and the cold rolling process, which are processes before the annealing process, on the hydrogen content in steel of the steel strip after heat treatment can be taken into consideration as indirect information in the process in the continuous galvanizing line. As a result, it is possible to predict the hydrogen content in steel as a prediction model of hydrogen content in steel.

As described above, in this embodiment, the transformation rate meter 20, which measures the ratio of austenite phase, is installed in at least one of the annealing process or the reheating process of the continuous galvanizing line, and the result of measurement by the transformation rate meter 20 is used as transformation rate information as one of training data for the prediction model of hydrogen content in steel.

### Attribute Parameter Related to Chemical Composition of Steel Strip

In this embodiment, it is preferable to further have at least one parameter selected from the attribute parameters of the steel strip related to the chemical composition of the steel strip as data to be input to the prediction model of hydrogen content in steel. This is because the phase transformation behavior and the internal microstructure during the heat treatment process are affected by the chemical composition of the steel strip. Further, in this case, it is possible to acquire a prediction model of hydrogen content in steel that predicts the hydrogen content in steel of steel strips with various chemical compositions for hot-dip galvanized steel sheets manufactured by the continuous galvanizing line, thereby expanding the scope of application of the prediction model of hydrogen content in steel.

Contents of C, Si, and Mn as chemical components contained in the steel strip can be used as the attribute parameters related to the chemical composition of the steel strip. The attribute parameters related to the chemical composition of the steel strip may also include contents of Cu, Ni, Cr, Mo, Nb, Ti, V, B, and Zr. However, it is not necessary to use all of these chemical components as attribute parameters related to the chemical composition of the steel strip. A part of these components may be appropriately selected according to the type of steel strip to be manufactured by the continuous galvanizing line.

C is an element effective in increasing the strength of a steel sheet, and it contributes to high strength by forming martensite, which is one of the hard phases in the steel microstructure.

Si is an element that contributes to high strength mainly through solid solution strengthening. The decrease in ductility is relatively small with respect to the increase in strength, so that it contributes not only to strength but also to an improvement in the balance between strength and ductility. On the other hand, Si tends to form Si-based oxides on the steel sheet surface, which may cause non-coating and stabilizes austenite during annealing, resulting in the formation of retained austenite in a final product.

Mn is an element effective in contributing to high strength through solid solution strengthening and martensite formation.

Nb, Ti, V, and Zr combine with C or N to form carbides or nitrides (or carbonitride in some cases) as fine precipitates, which contributes to high strength of a steel sheet.

Cu, Ni, Cr, Mo, and B are elements that contribute to high strength because they enhance the hardenability and facilitate the formation of martensite.

These chemical components have a substantially constant distribution in the longitudinal direction of a steel strip, and one attribute parameter can be acquired as performance data for one steel strip.

Further, in addition to the attribute parameters of the steel strip related to the chemical composition of the steel strip, attribute parameters related to the dimensions of the steel strip, such as the thickness, width, and length of the steel strip, may be used as training data of the prediction model of hydrogen content in steel in this embodiment. This is because they affect the heat transfer in the continuous galvanizing line and thus affect the hydrogen content in steel of the steel strip due to different temperature changes in the steel sheet, even at the same furnace atmosphere temperature.

### Method of Controlling Hydrogen Content in Steel of Steel Strip

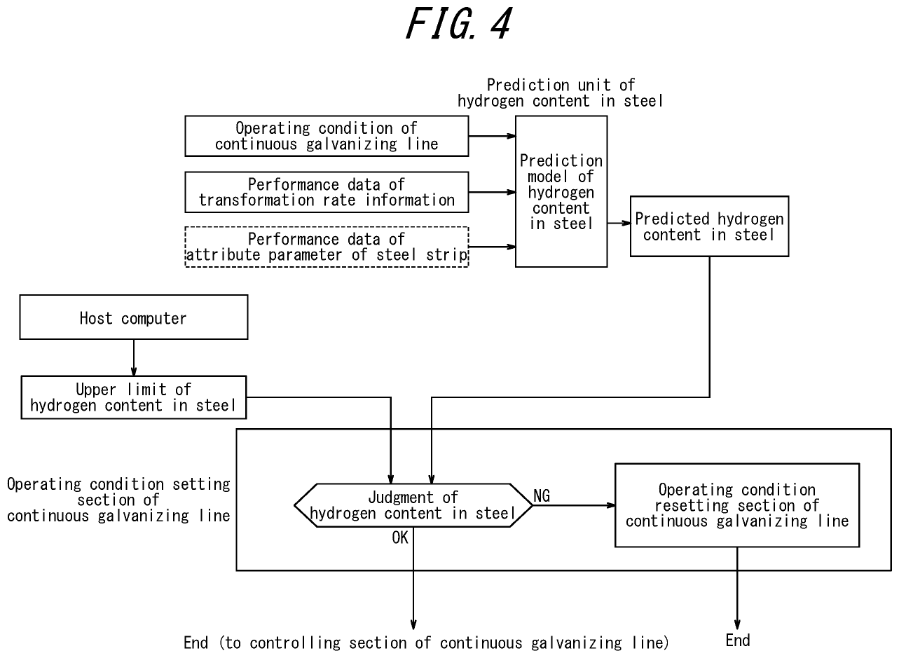

FIG. 4 illustrates a method of controlling hydrogen content in steel of a steel strip using the method of predicting hydrogen content in steel as described above.

A method of controlling hydrogen content in steel according to this embodiment differs depending on the installation position of the transformation rate meter 20 installed in at least one of the annealing process or the reheating process of the continuous galvanizing line. Specifically, when a plurality of transformation rate meters 20 are installed for transformation rate information to be input to the prediction model of hydrogen content in steel formed as described above, there are two zones of a zone on the upstream side of the transformation rate meter 20 installed on the most downstream side and a zone on the downstream side thereof. The zone from the entry side of the continuous galvanizing line to the transformation rate meter 20 is called an identification zone of hydrogen content in steel. The zone downstream of the transformation rate meter 20 is called a controlling zone of hydrogen content in steel. When the lead end of the steel strip to be subjected to prediction of hydrogen content in steel reaches the position of the transformation rate meter 20 and the transformation rate information of the steel strip is acquired, the control flow illustrated in FIG. 4 is started.

For the steel strip whose hydrogen content in steel is to be controlled, the operational performance data of the continuous galvanizing line acquired in the identification zone of hydrogen content in steel of the continuous galvanizing line and the transformation rate information measured by the transformation rate meter 20 are data to be input to the prediction model of hydrogen content in steel. The process of acquiring these input data may be referred to as input data acquisition. In the input data acquisition, the operational performance data of the continuous galvanizing line in the controlling zone of hydrogen content in steel at that time or the set values of the operating conditions of the continuous galvanizing line may be further acquired as data to be input to the prediction model of hydrogen content in steel. Using the data thus acquired as input data, the prediction model of hydrogen content in steel is used to predict the hydrogen content in steel of the steel strip on the downstream side of the reheating process.

On the other hand, in this embodiment, an upper limit of the hydrogen content in steel of the steel strip is further set in the host computer, and the predicted hydrogen content in steel is compared with the upper limit. With respect to steel materials to be used in environments where hydrogen embrittlement cracking may be a problem in practice, the upper limit of the hydrogen content in steel is preferably set as a value that is higher than the target value, to which the hydrogen content in steel of the steel strip is to be reduced, to the extent that problems do not occur in practice. For example, the upper limit of the hydrogen content in steel may be set as 0.40 ppm.

An operating condition setting section of the continuous galvanizing line compares the predicted hydrogen content in steel with the upper limit of the hydrogen content in steel that has been set as described above. If the predicted hydrogen content in steel is equal to or lower than the upper limit, the operating conditions of the continuous galvanizing line are determined as initially set and sent to the controlling section of the continuous galvanizing line. On the other hand, if the predicted hydrogen content in steel exceeds the upper limit, the operating conditions in the controlling zone of hydrogen content in steel are reset.

Specifically, when the most downstream transformation rate meter 20 in the continuous galvanizing line (meaning the one on the most downstream side among the transformation rate meters 20 that provide transformation rate information to be input to the prediction model of hydrogen content in steel) is installed at the outlet of the soaking zone 7 in the annealing process, the area from the entry side of the continuous galvanizing line to the outlet of the soaking zone 7 is the identification zone of hydrogen content in steel, and the downstream side of the outlet of the soaking zone 7 is the controlling zone of hydrogen content in steel. When the lead end of the steel strip reaches the outlet of the soaking zone 7 and the transformation rate information is acquired by the transformation rate meter 20, the flow of controlling the hydrogen content in steel illustrated in FIG. 4 is started. In the controlling zone of hydrogen content in steel, operating conditions selected from cooling conditions in the cooling zone 8 (first cooling zone 8A and second cooling zone 8B), atmosphere temperature inside the snout 19 in the coating section, operating conditions such as injection pressure of the wiping device 21, reheating conditions in the alloying zone 17, holding temperature and holding time in the holding zone 18, and cooling rate in the final cooling zone 11 can be reset as operating conditions that can be used to control the hydrogen content in steel. The operating conditions to be reset are not necessarily limited to those to be input to the prediction model of hydrogen content in steel.

On the other hand, when the most downstream transformation rate meter 20 is installed at the inlet or outlet of the alloying zone 17, the controlling zone of hydrogen content in steel is limited to an area after the holding zone 18 or the final cooling zone 11. Therefore, the operating conditions to be reset in the continuous galvanizing line are limited to the holding time in the holding zone 18, the mixing ratio of the atmosphere gas components of the holding zone 18, the cooling rate of the final cooling zone 11, and the like.

Therefore, the position of the most downstream transformation rate meter 20 for the input of the prediction model of hydrogen content in steel may be appropriately determined based on the balance between the degree of freedom of the operating conditions to be reset and the prediction accuracy of the prediction model of hydrogen content in steel. In other words, increasing the length of the identification zone of hydrogen content in steel improves the prediction accuracy of hydrogen content in steel, but it reduces the degree of freedom of operating conditions that can be reset in the controlling zone of hydrogen content in steel. In contrast, decreasing the length of the identification zone of hydrogen content in steel reduces the prediction accuracy of hydrogen content in steel, but it improves the degree of freedom of operating conditions that can be reset in the controlling zone of hydrogen content in steel.

A steel strip having an internal microstructure mainly composed of γ phase is less likely to release the hydrogen in steel, and hydrogen is likely to be released as the ratio of α phase increases. Therefore, it is preferable to set the controlling zone of hydrogen content in steel downstream of the cooling zone 8 in the annealing section to effectively reduce the hydrogen content in steel. As described above, when a plurality of transformation rate meters 20 are installed in the continuous galvanizing line, it is preferable to separate the identification zone of hydrogen content in steel and the controlling zone of hydrogen content in steel with the transformation rate meter 20 on the most downstream side as a reference. However, the transformation rate meter 20 for separating the identification zone of hydrogen content in steel and the controlling zone of hydrogen content in steel does not necessarily have to be the transformation rate meter 20 on the most downstream side. The identification zone of hydrogen content in steel and the controlling zone of hydrogen content in steel may be separated with any transformation rate meter selected from the plurality of transformation rate meters 20 as a reference.

### Device That Predicts Hydrogen Content in Steel

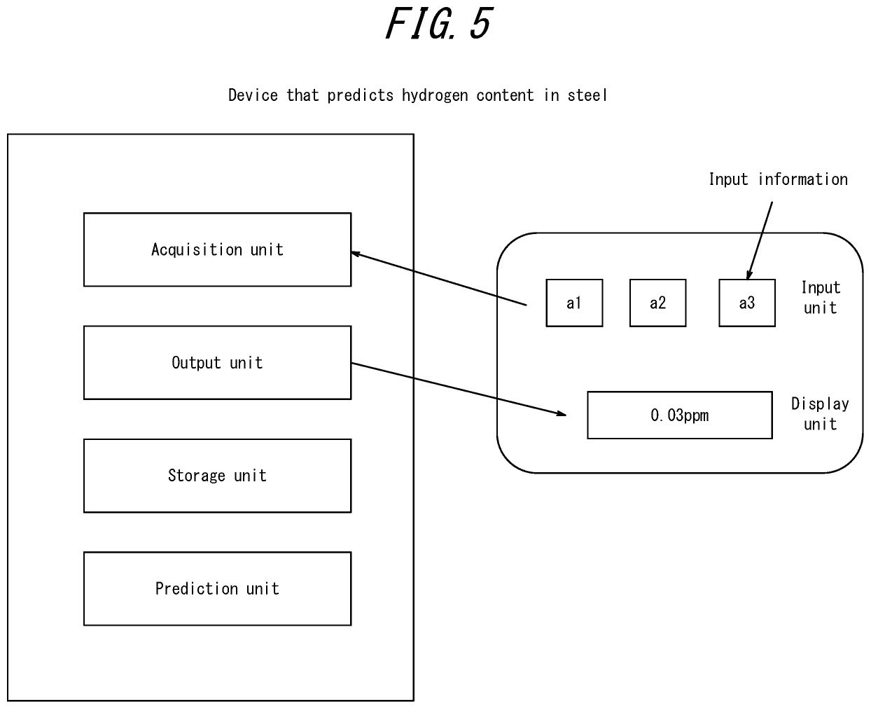

FIG. 5 illustrates the configuration of a device that predicts hydrogen content in steel. The device that predicts hydrogen content in steel has an acquisition unit, an output unit, a storage unit, and a prediction unit.

The acquisition unit includes, for example, any interface that can acquire the prediction model of hydrogen content in steel formed by a machine learning unit from a device that forms the prediction model of hydrogen content in steel. For example, the acquisition unit may include a communication interface for acquiring a prediction model of hydrogen content in steel from a device that forms the prediction model of hydrogen content in steel. In this case, the acquisition unit may receive the prediction model of hydrogen content in steel from the machine learning unit via a predetermined communication protocol.

Further, the acquisition unit acquires the operating conditions of the continuous galvanizing line from, for example, the process computer or the host computer. For example, the acquisition unit may include a communication interface for acquiring the operating conditions.

The acquisition unit may acquire input information based on a user's operation. In this case, the device that predicts hydrogen content in steel further has an input unit including at least one input interface that detects a user's input and acquires input information based on the user's operation. Examples of the input unit include, but are not limited to, a physical key, a capacitive key, a touch screen provided integrally with a display of the output unit, and a microphone that receives voice input. For example, the input unit receives input of operating conditions for the prediction model of hydrogen content in steel acquired by the acquisition unit from the device that forms the prediction model of hydrogen content in steel.

The storage unit includes at least one semiconductor memory, at least one magnetic memory, at least one optical memory, or a combination of at least two of these. The storage unit functions as, for example, a main storage device, an auxiliary storage device, or a cache memory. The storage unit stores any information used in the operation of the device that predicts hydrogen content in steel. The storage unit stores, for example, the prediction model of hydrogen content in steel acquired from the device that forms the prediction model of hydrogen content in steel by the acquisition unit, the operating conditions acquired from the host computer by the acquisition unit, and the information on the hydrogen content in steel predicted by the prediction unit. For example, the storage unit may store system programs, application programs, and the like.

The prediction unit includes at least one processor. In one embodiment, the “processor” may be a general-purpose processor, or a dedicated processor specialized for specific processing, but it is not limited to these processors. The prediction unit is communicably connected to each component constituting the device that predicts hydrogen content in steel, and it controls the operation of the device that predicts hydrogen content in steel as a whole.

The prediction unit may be, for example, any general-purpose electronic device such as a personal computer (PC) or a smart phone. The prediction unit may be, but is not limited to, one server device or a plurality of server devices that can communicate with each other, or another electronic device dedicated to a prediction system of hydrogen content in steel.

The prediction unit calculates a predicted value of the hydrogen content in steel based on the operating conditions acquired via the acquisition unit and based on the prediction model of hydrogen content in steel acquired from the device that forms the prediction model of hydrogen content in steel.

The output unit supplies the predicted value of the hydrogen content in steel supplied from the prediction unit to an operating condition setting device, which will be described later.

The output unit may include at least one output interface for outputting information and notifying a user. The interface for output is, for example, a display. The display is, for example, an LCD or an organic EL display. The output unit outputs the acquired data by the operation of the device that predicts hydrogen content in steel. The output unit may be connected to the device that predicts hydrogen content in steel as an external output device instead of being provided in the device that predicts hydrogen content in steel. Any method such as USB, HDMI® (HDMI is a registered trademark in Japan, other countries, or both), or Bluetooth® (Bluetooth is a registered trademark in Japan, other countries, or both) may be used as a connection method. Examples of the output unit include, but are not limited to, a display that outputs information as video, and a speaker that outputs information as audio. For example, the output unit presents the predicted value of the hydrogen content in steel predicted by the prediction unit to a user. A user can appropriately set the operating conditions of the continuous hot-dip galvanizing line based on the predicted value of the information on the hydrogen content in steel presented by the output unit.

A more preferred embodiment of the device that predicts hydrogen content in steel of a steel strip as described above is a device that predicts hydrogen content in steel that includes, as a tablet terminal, a terminal device having an input unit for acquiring input information based on a user's operation, and a display unit for displaying the hydrogen content in steel by a prediction unit. It acquires input information based on a user's operation from the input unit and uses the acquired input information to update some or all of the operation parameters of the continuous galvanizing line that have been input to the prediction model of hydrogen content in steel. In other words, when the hydrogen content in steel of a steel strip being processed in the continuous galvanizing line is predicted by the prediction unit of the device that predicts hydrogen content in steel, an operator uses the tablet terminal to receive an operation of correcting a part of the operation parameters of the continuous galvanizing line that have been input to the acquisition unit. The acquisition unit retains the original input data for the operation parameters of the continuous galvanizing line for which no correction is input from the tablet terminal, and changes only those operation parameters for which correction is input. As a result, the acquisition unit forms new input data for the prediction model of hydrogen content in steel, and the prediction unit calculates a predicted value of hydrogen content in steel based on the input data. Further, the calculated predicted value of hydrogen content in steel is displayed on the display unit of the terminal through the output unit.

In this way, a person in charge of the operation of the continuous galvanizing line or a person in charge of factory or the like can immediately check the predicted value of hydrogen content in steel when the operation parameters of the continuous galvanizing line are changed, thereby quickly changing to appropriate operating conditions.

### Example of First Embodiment

The following describes this embodiment in detail with reference to examples.

In the hot-dip galvanizing line illustrated in FIG. 1, 200 coils of hot-dip galvanized steel sheet (where the upper limit of hydrogen content in steel was 0.40 ppm) were manufactured. The performance data of the attribute information of a steel sheet to be charged into the hot-dip galvanizing line and the operational performance data of the operation parameters in the hot-dip galvanizing line were used as input performance data, and the hydrogen content in steel of the steel sheet at the delivery-side of the hot-dip galvanizing line using the input performance data was used as output performance data, to acquire a plurality of training data. Through machine learning using the plurality of training data acquired, a prediction model of hydrogen content in steel was formed with the method illustrated in FIG. 3, where information on the hydrogen content in steel of a steel strip downstream of the reheating process was used as output data.

During the formation of the prediction model of hydrogen content in steel, C, Si, and Mn contents were used as attribute parameters of the steel strip related to the chemical composition of the steel strip to be input. Further, the temperature of the steel sheet in the soaking zone 7 and the transport speed at which the lead end of the steel strip passed through the soaking zone 7 were input as operational performance data of the continuous galvanizing line. In this embodiment, on-line transformation rate meters 20 were installed at two positions of the outlet of the soaking zone 7 and the inlet of the holding zone 18 of the continuous galvanizing line illustrated in FIG. 1, and the performance data of transformation rate information measured by these transformation rate meters were used as input performance data. Further, in this embodiment, the set values of the thickness and width of the steel strip were used as other inputs to form a prediction model of hydrogen content.

Here, the hydrogen content in steel of the steel strip acquired as training data was the hydrogen content in steel acquired with a temperature rise hydrogen analysis method by gas chromatograph, where a test piece was collected after the strip had passed through the hot-dip galvanizing line.

The prediction model of hydrogen content in steel thus formed was applied to a prediction unit of hydrogen content in steel for controlling hydrogen content in steel as illustrated in FIGS. 4, and 100 coils of hot-dip galvanized steel sheet were manufactured. In other words, a method of predicting hydrogen content in steel of a steel strip using the prediction model of hydrogen content in steel was applied to a method of controlling hydrogen content in steel of a steel strip and a manufacturing method.

The hydrogen content in steel of the steel sheet at the delivery side of the hot-dip galvanizing line was predicted using the prediction model of hydrogen content in steel, and the operation parameters of the hot-dip galvanizing line were reset so that the predicted hydrogen content in steel would be equal to or lower than a preset upper limit (in this case, it was set at 0.40 ppm). Since the most downstream transformation rate meter 20 was installed at the inlet of the holding zone 18, the area from the entry side of the continuous galvanizing line to the inlet of the holding zone 18 was the identification zone of hydrogen content in steel, and the area downstream of the inlet of the holding zone 18 was the controlling zone of hydrogen content in steel. The flow illustrated in FIG. 4 was started after the lead end of the steel strip reached the inlet of the holding zone 18. In the controlling zone of hydrogen content in steel, the holding temperature and holding time in the holding zone 18 and the cooling rate in the cooling zone 8 were reset as operating conditions to be used to control the hydrogen content in steel.

After that, the hydrogen content in steel of these steel strips acquired by the hydrogen content in steel measurement test were collected. As a result, 95% of the steel strips had a hydrogen content in steel equal to or lower than the upper limit (0.40 ppm).

On the other hand, a similar experiment was conducted with the method described in PTL 1 as a comparative example. As a result, 65% of the steel strips had a hydrogen content in steel equal to or lower than the upper limit.

### Second Embodiment

A method of predicting hydrogen content in steel of a steel strip of a second embodiment of this disclosure predicts the hydrogen content in steel of a cold-rolled steel sheet at the delivery side of a continuous annealing line, where the cold-rolled steel sheet is manufactured by subjecting a steel sheet, whose thickness has been reduced to a specified value through a hot rolling process, a pickling process, and a cold rolling process, to heat treatment by a continuous annealing line. The thin steel sheet is coiled and then subjected to heat treatment and the like at least after the hot rolling process. Therefore, the thin steel sheet may be referred to as “steel strip” in this embodiment.

### Continuous Annealing Line

In this embodiment, the continuous annealing line is a continuous annealing line (CAL) that performs manufacturing processes including an annealing process and a reheating process. The following describes the continuous annealing line in detail with reference to the drawings.

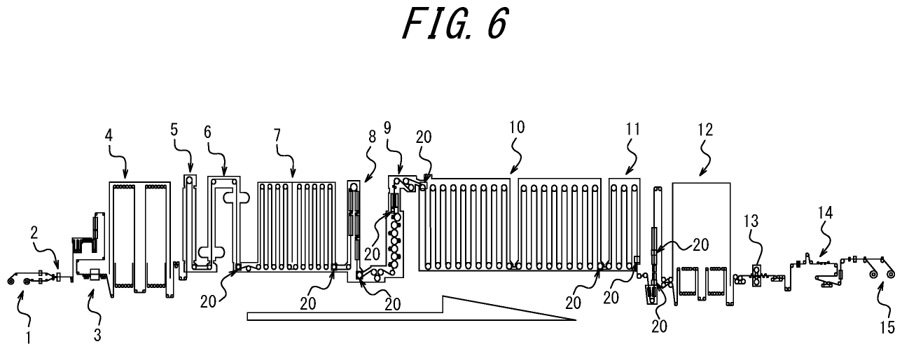

FIG. 6 schematically illustrates an example of a continuous annealing line used to manufacture cold-rolled steel sheets. The arrow in FIG. 6 indicates the travel direction of a steel strip. The continuous annealing line is roughly divided into entry-side equipment, a furnace section, and delivery-side equipment. The entry-side equipment includes a payoff reel 1, a welder 2, an electrolytic cleaning device 3, and an entry-side looper 4. The furnace section includes an annealing section and a reheating section. The delivery-side equipment includes a delivery-side looper 12, a temper rolling system 13, an inspection system 14, and a tension reel 15. The inspection system 14 has a sample collection system that collects a sample material from the steel strip for offline measurement of hydrogen content in steel.

The annealing section has a heating zone 6, a soaking zone 7, and a cooling zone 8, and it may have a preheating zone 5 upstream of the heating zone 6. The annealing process in this embodiment is a heat treatment process performed in the annealing section. More specifically, the annealing process is a process of heating the steel strip from around room temperature, holding the steel strip at a predetermined temperature, and then lowering the temperature of the steel strip to around room temperature. The reheating section has a reheating zone 9, an overaging zone 10, and a final cooling zone 11, where the reheating zone 9 is equipped with an induction heating device. The reheating process in this embodiment is a heat treatment process performed in the reheating section. More specifically, the reheating process is a process of overaging the steel strip that has passed through the cooling zone 8.

The heating zone 6 is a system for raising the temperature of the steel strip, and it heats the steel strip to a preset temperature in a range of about 600° C. to 900° C. depending on the type of the steel. In the heating zone 6, direct fire or a radiant combustion burner is used. These heating devices have a large heat capacity and relatively fast responses, rendering it easy to change the temperature history when changing heat cycles. The soaking zone 7 is a system that maintains the steel strip at a predetermined temperature, and it has a heating capacity sufficient to compensate for heat dissipation from the furnace body and the like.

The cooling zone 8 is a system for cooling the steel strip to a predetermined temperature, and gas jet cooling, roll-chilling, water cooling (water quenching) and the like are used as cooling means. The gas jet cooling is a cooling means of blowing gas from a nozzle onto the surface of the steel strip. The roll-chilling is a cooling means of cooling the steel strip by contacting it with a water-cooled roller. The water cooling is cooling means of cooling the steel strip by immersing it in a water-cooling tank installed downstream of the soaking zone 7. Because the cooling rate of the steel strip by these cooling devices differs, the cooling zone 8 may be divided into a plurality of zones, such as the first cooling zone 8A and the second cooling zone 8B, and the thermal history of the steel strip during cooling may be controlled by combining different cooling means or changing the cooling conditions of the same cooling means.

A mixed gas containing hydrogen, nitrogen, and water vapor is supplied inside each of the heating zone 6, the soaking zone 7, and the cooling zone 8 to adjust the atmosphere during the annealing process. Since the supplied gas contains water vapor, not only the gas composition but also the dew point of the atmosphere during the annealing process is adjusted.

The reheating zone 9 is arranged downstream of the cooling zone 8, and after the steel strip is cooled to a predetermined temperature in the cooling zone 8, it is reheated to a temperature of about 300° C. to 400° C. using an induction heating device. The overaging zone 10 is a system for performing overaging treatment in which the reheated steel strip is held for a predetermined period of time. The final cooling zone 11 is a system for final cooling of the overaged steel strip to around room temperature. As with the cooling zone 8, the final cooling zone 11 may be divided into a plurality of zones such as a first final cooling zone 11A and a second final cooling zone 11B to control the thermal history during cooling of the steel strip.

In the continuous galvanizing line, thermometers are installed at a plurality of positions to measure the surface temperature of the steel strip in the heating zone 6, the soaking zone 7, and the cooling zone 8 of the annealing section, and the reheating zone 9, the overaging zone 10, and the final cooling zone 11 of the reheating process. Especially in the cooling zone 8 where the temperature variation of the steel strip is large, thermometers are installed at the entry side and the delivery side of the cooling zone 8, and the actual cooling rate of the cooling zone 8 is calculated by measuring the surface temperature of the steel strip at these positions. For example, a radiation thermometer is used to continuously measure the surface temperature at the center of the steel strip width as a thermometer. The thermometer is not limited to a radiation thermometer, and it may be a profile radiation thermometer that measures the temperature distribution in the sheet transverse direction as another example. Further, furnace thermometers are installed to measure not only the surface temperature of the steel strip but also the atmosphere temperature inside the furnace in each zone of the annealing process and the reheating process. The measured surface temperature of the steel strip and the atmosphere temperature are output to a process computer that controls the continuous annealing line and supervises the operation.

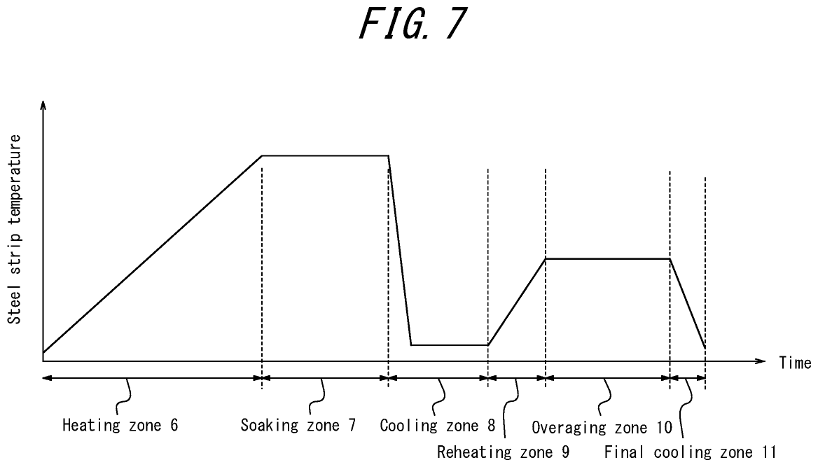

FIG. 7 is a graph illustrating the thermal history of the steel strip in the continuous annealing line used to manufacture cold-rolled steel sheets, including the annealing process and the reheating process. The horizontal axis indicates time, and the vertical axis indicates steel strip temperature. The steel strip temperature is, for example, the surface temperature of the steel strip. It illustrates the thermal history of the steel strip that has undergone an annealing process by the heating zone 6, the soaking zone 7, and the cooling zone 8, and then undergone a reheating process by the reheating zone 9, the overaging zone 10, and the final cooling zone 11. To prevent variations in material properties depending on the longitudinal position of the steel strip, the transport speed of the steel strip is kept constant during the annealing process. However, when steel strips with different thicknesses, widths, steel grades, etc. are welded together, the line speed may change before and after the welded portion. Therefore, the shape of the graph of the thermal history may vary depending on the measurement position of the steel strip. Depending on the operating conditions, the reheating process by the reheating zone 9, the overaging zone 10, and the final cooling zone 11 may not be performed. In such a case, the temperature of the steel strip that has passed through the cooling zone 8 is about room temperature and has a substantially constant thermal history.

### Control of Atmosphere Gas

A mixed gas containing hydrogen, nitrogen, and water vapor is supplied inside each of the heating zone 6, the soaking zone 7, and the cooling zone 8, by which the annealing process is performed, to control the atmosphere of the annealing process. Since hydrogen contained in the atmosphere of the annealing process affects the amount of hydrogen that enters the steel strip during the annealing process, the composition and the flow rate of the input gas are measured, and adjusted and controlled as necessary.

In the heating zone 6, the steel strip can be heated indirectly using a heating device such as a radiant tube (RT) or an electric heater. The heating zone 6 may be supplied with a reducing gas or a non-oxidizing gas while the gases from the soaking zone 7 and the cooling zone 8 flowing into the heating zone 6. A H₂—N₂ mixed gas is usually used as the reducing gas. Examples of such a H₂—N₂ mixed gas include a gas (dew point: about −60° C.) having a composition of 1% by volume to 20% by volume of H₂, with the balance being N₂ and inevitable impurities. Further, a gas (dew point: about −60° C.) having a composition of N₂ and inevitable impurities is used as the non-oxidizing gas. A method of supplying the gas to the heating zone 6 is not limited, but it is preferable to supply the gas from at least two supply ports in the height direction and at least one supply port in the longitudinal direction so that the gas is uniformly introduced into the heating zone 6.

In the soaking zone 7, the steel strip may be heated indirectly using a radiant tube as a heating means. The average temperature inside the soaking zone 7 is preferably 700° C. to 90° C. A reducing gas or a non-oxidizing gas is supplied to the soaking zone 7. A H₂—N₂ mixed gas is usually used as the reducing gas, and examples thereof include a gas (dew point: about −60° C.) having a composition of 1% by volume to 20% by volume of H₂, with the balance being N₂ and inevitable impurities. Further, examples of the non-oxidizing gas include a gas (dew point: about −60° C.) having a composition of N₂ and inevitable impurities.

The cooling zone 8 is equipped with a cooling device, and the steel strip is cooled when it passes through the cooling zone 8. The cooling zone 8 can also be supplied with the above-described gas, as in the soaking zone 7. It is preferable to supply the gas from at least two supply ports in the height direction and at least two supply ports in the longitudinal direction of the cooling zone 8 so that the gas is uniformly introduced into the cooling zone 8.

A hydrogen concentration meter and a dew point meter for measuring the gas atmosphere inside the furnace are installed in the heating zone 6, the soaking zone 7, and the cooling zone 8 in which the annealing process is performed. The hydrogen concentration meter uses a contact combustion type sensor that measures the rising temperature of a platinum wire coil due to the contact combustion of gas on the surface of a catalyst. For example, a combustible gas detector XP-3110 manufactured by NEW COSMOS ELECTRIC CO., LTD. can be used. However, hydrogen concentration meters based on other measurement methods may be used, such as one that detects the hydrogen concentration based on changes in thermal conductivity depending on the gas concentration. A capacitance-type dew point meter or a mirror surface cooling-type dew point meter may be used. For example, a DMT345 dew point transducer manufactured by VAISALA may be used.

It is preferable to install the hydrogen concentration meter in any of the heating zone 6, the soaking zone 7, and the cooling zone 8. The hydrogen concentration meter may be installed at any position in the heating zone 6, the soaking zone 7, and the cooling zone 8. However, since hydrogen in steel diffuses more easily as the temperature of the steel strip increases, it is preferable to install the hydrogen concentration meter near the delivery side of the heating zone 6 or in the soaking zone 7. The hydrogen concentration meter may be installed at any one position, but it is preferable to install a plurality of hydrogen concentration meters at different positions. This is because acquiring a plurality of pieces of hydrogen concentration information improves the prediction accuracy of the hydrogen content in steel. The measured values are output to the process computer.

The same applies to the dew point meter, where it is preferable to install the dew point meter in any of the heating zone 6, the soaking zone 7, and the cooling zone 8. The dew point meter may be installed at any position in the heating zone 6, the soaking zone 7, and the cooling zone 8. The dew point meter may be installed at any one position, but it is preferable to install a plurality of dew point meters at different positions. This is because acquiring a plurality of pieces of dew point information improves the prediction accuracy of the hydrogen content in steel. The measured values are output to the process computer.

A mixed gas containing hydrogen, nitrogen, and water vapor is supplied inside each zone of the reheating process to control the atmosphere. Since hydrogen contained in the atmosphere affects the amount of hydrogen that enters the steel strip in the reheating process, the composition and flow rate of the input gas are measured, and adjusted and controlled as necessary.

The reheating process is also equipped with a hydrogen concentration meter and a dew point meter to measure the gas atmosphere. The hydrogen concentration meter and the dew point meter may be installed at any position. One hydrogen concentration meter and one dew point meter may be installed, respectively. However, it is preferable to install a plurality of hydrogen concentration meters and dew point meters at different positions. This is because acquiring a plurality of pieces of hydrogen concentration meter information and dew point information improves the prediction accuracy of the hydrogen content in steel. The measured values are output to the process computer.

### Transformation Rate Meter

A transformation rate meter 20 is a meter that measures a ratio of austenite phase (γ phase) to the whole internal microstructure of the steel strip in the heat treatment process. In the continuous annealing line, the microstructure of a steel sheet is often controlled using phase transformation from a specific two-phase state of austenite phase (γ phase) and ferrite phase (α phase). Therefore, the transformation rate meter 20 may be a transformation rate meter 20 that uses X-ray diffraction. Because the crystal structures of the γ phase and the α phase are different, each produces diffraction peaks at unique angles when exposed to X-rays. This is a method of quantifying the transformation rate (γ rate) based on the diffraction peak intensity. For example, a product called X-CAP, which is manufactured by SMS, may be used. Further, a method of measuring the austenite phase rate using a magnetic transformation rate measuring device may be used, where the magnetic transformation rate measuring device includes a driving coil that forms a magnetic field and a detection coil that measures the magnetic field through which the steel strip is passed, and the magnetic transformation rate measuring device is used as a magnetic detector, i.e. a device that measures the magnetic transformation rate of the steel strip. Specifically, the device described in JP 2019-7907 A may be used.

In this embodiment, such a transformation rate meter 20 that measures the austenite phase rate is installed in at least one of the annealing process or the reheating process of the continuous annealing line. For example, the transformation rate meters 20 in FIG. 6 indicate candidate positions for installation. The positions for installation are, for example, at the inlet of soaking zone 7, at the outlet of the soaking zone 7, and at the inlet of the cooling zone 8 in the annealing process, and it is preferably installed at the inlet or outlet of the reheating zone 9 in the reheating process. The transformation rate meter 20 may be installed at any one position, but it is preferable to install a plurality of transformation rate meters 20 at different positions. This is because acquiring a plurality of pieces of transformation rate information improves the prediction accuracy of the hydrogen content in steel.

### Information on Hydrogen Content in Steel of Steel Strip

The information on the hydrogen content in steel is a value of diffusible hydrogen content obtained by collecting a test piece from a sample material of the steel strip collected in the sample collection system of the continuous annealing line and measuring the sample material by an off-line device for measuring the hydrogen content in steel. The device for measuring the hydrogen content in steel may be any measuring device that can measure the amount of hydrogen contained in steel in a range of 0.01 ppm to 10 ppm. Specifically, a measuring device based on a temperature rise hydrogen analysis method by gas chromatograph may be used.

Examples of methods of measuring the hydrogen content include gas chromatography-mass spectrometry (GC/MS) and thermal desorption spectroscopy (TDS). Examples of the device include GC-4000 Plus of GL Sciences Inc., and TDS1200 of UBE Scientific Analysis Laboratory, Inc.

The hydrogen content in steel can be measured by thermal desorption analysis as follows. First, a test piece of about 5 mm×30 mm is cut from the cold-rolled steel sheet. The surface of the test piece is removed using a router (precision grinder), and the test piece is placed in a quartz tube. Next, after replacing the inside of the quartz tube with Ar, the temperature is raised at 200° C./hr, and hydrogen formed up to 400° C. is measured by gas chromatography. In this case, the diffusible hydrogen content in steel is the cumulative amount of hydrogen detected in the temperature range from room temperature (25° C.) to 400° C.

The information on the hydrogen content in steel of the steel strip thus obtained is sent to a host computer (a computer that gives manufacturing instructions to the process computer) together with the identification number (coil number) of the steel strip from which the test piece is collected and, if necessary, the information on the sampling position.

### Method of Forming Prediction Model of Hydrogen Content in Steel

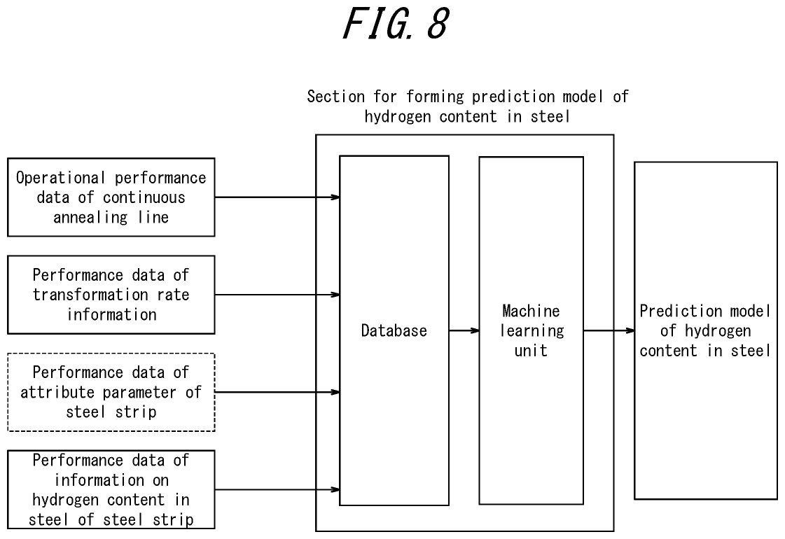

FIG. 8 illustrates a method of forming a prediction model of hydrogen content in steel of a steel strip according to this embodiment.

Operational performance data of the continuous annealing line, performance data of the transformation rate information of the steel strip measured by the transformation rate meter 20, and performance data of the information on the hydrogen content in steel of the steel strip are stored in a database. The details of the operational performance data of the continuous annealing line will be described below. Performance data selected from the operational performance data in the process computer that controls the operation of the continuous annealing line is sent to a database of a section for forming a prediction model of hydrogen content in steel. The performance data of the transformation rate information of the steel strip is the transformation rate information acquired from the transformation rate meter 20, and if the transformation rate information is stored in the process computer, it is sent from the process computer to the database. However, if the transformation rate information is not stored in the process computer, it is sent directly to the database of the section for forming a prediction model of hydrogen content in steel.

The information on the hydrogen content in steel is sent to the database together with ancillary information that can be correlated with the operational performance data of the continuous annealing line, such as the coil number of the steel strip. Further, the performance data of the information on the hydrogen content in steel of the steel strip is information obtained by an off-line test, and it is stored in the host computer. This information is also sent to the database together with ancillary information that can be correlated with the operational performance data of the continuous annealing line, such as the coil number of the steel strip. The operational performance data of the continuous annealing line, the performance data of the transformation rate information of the steel strip measured by the transformation rate meter 20, and the performance data of the information on the hydrogen content in steel of the steel strip are correlated with each other by the coil number or the like, and they are stored in the database as a set of data. In this case, for the sets of data stored in the database, each steel strip acquires one set of data. However, if the performance data of the information on the hydrogen content in steel of the steel strip is acquired at a plurality of positions, such as the lead end and the tail end of the steel strip, one steel strip may acquire a plurality of sets of data using the operational performance data of the continuous annealing line and the performance data of the transformation rate information of the steel strip acquired at the plurality of positions such as the lead end and the tail end of the steel strip.

The database preferably has at least one parameter selected from attribute parameters of the steel strip related to the chemical composition of the steel strip. The performance data of the attribute parameter of the steel strip related to the chemical composition of the steel strip is stored together with the coil number in the process computer or the host computer as the performance value in the steelmaking process, and it may be sent to the database as appropriate to constitute a set of data. By adding the attribute parameter of the steel strip related to the chemical composition of the steel strip as input, the prediction model of hydrogen content in steel in this embodiment can be widely applied to steel strips with different chemical compositions.

The number of sets of data in the database used to form a prediction model of hydrogen content in steel in this embodiment is preferably 200 or more and more preferably 1000 or more.

In this embodiment, the database thus created is used to form a prediction model of hydrogen content in steel of the steel strip, where at least one operational performance data selected from the operational performance data of the continuous annealing line and the performance data of the transformation rate information measured by the transformation rate meter 20 installed at one or more positions in either the annealing process or the reheating process are at least used as input performance data, and the prediction model is trained by machine learning using the input performance data.

Any known machine learning method can be applied as the machine learning method, and any machine learning model can be used as long as it provides sufficient accuracy in predicting the hydrogen content in steel of a steel sheet in practice. For example, known machine learning methods using neural networks, including deep learning, convolutional neural networks (CNN), and recurrent neural networks (RNN), may be used. Examples of other methods include decision tree learning, random forests, support vector regression, and Gaussian processes. An ensemble model combining a plurality of models may also be used. The prediction model of hydrogen content in steel may be updated as appropriate using the latest training data.

In this case, it can respond to long-term changes in operating conditions of the continuous annealing line.

### Operation Parameter of Continuous Annealing Line

Any operation parameter that affects the hydrogen content in steel of the steel strip other than the transformation rate information measured by the transformation rate meter 20 can be used as an operation parameter of the continuous annealing line. The operation parameters in the continuous annealing line are roughly classified into operation parameters related to the thermal history of the steel strip and operation parameters related to the atmosphere gas of the continuous annealing line in which the steel strip is passed.

### Operation Parameter Related to Thermal History

Based on the example of the thermal history of a steel strip during the annealing process and the reheating process illustrated in FIG. 7, operation parameters in the continuous annealing line as follows may be used.

For example, the time the steel strip takes to pass through the heating zone 6 and the temperature rise during the passing, or the average heating rate calculated based on these values may be used as the operation parameter of the heating zone 6.

The soaking temperature, which is the average temperature of the steel strip in the soaking zone 7, and the soaking time, which is the time to pass through the soaking zone 7, may be used as the operation parameters of the soaking zone 7. The time the steel strip takes to pass through the first cooling zone 8A and the temperature drop during the passing, or the average cooling rate calculated based on these values may be used as the operation parameters of the cooling zone 8. Further, the time the steel strip takes to pass through the second cooling zone 8B and the temperature drop during the passing, or the average cooling rate calculated based on these values may be used as the operation parameter of the cooling zone 8.

The control output value of a heating device in the heating zone 6 and the control output value of a cooling device in the cooling zone 8 may be used as the operation parameters. This is because these operation parameters are operation parameters used to control the temperature history of the steel strip during the annealing process. Further, the line speed of the steel strip in the soaking zone 7, the average cooling rate in the cooling zone 8, and the injection pressure of a cooling device such as gas injection may be used. This is because these factors also affect the thermal history of the steel strip.

The temperature rise measured by radiation thermometers arranged at the entry side and the delivery side of the induction heating device installed in the reheating zone 9 and the passage time, or the average heating rate calculated based on these values may be used as the operation parameters of the reheating zone 9. The average temperature of the steel strip in the overaging zone 10 and the time it takes to pass through the overaging zone 10 may be used as the operation parameters of the overaging zone 10. The time the steel strip takes to pass through the final cooling zone 11 and the temperature drop during the passing, or the average cooling rate calculated based on these values may be used as the operation parameters of the final cooling zone 11. Further, the control output value of a heating device in the reheating zone 9 and the control output value of a cooling device in the final cooling zone 11 may be used as the operation parameters. This is because these operation parameters are operation parameters used to control the temperature history of the steel strip during the reheating process.

### Operation Parameter Related to Atmosphere Gas

In addition to the operation parameters related the thermal history of the steel strip described above, operation parameters related to the atmosphere gas of the continuous annealing line in which the steel strip is passed may be selected as the operation parameters in the continuous annealing line according to this embodiment.

The gas composition of the atmosphere gas in each of the heating zone 6, the soaking zone 7, and the cooling zone 8 may be used as operation parameters in the annealing section. It is particularly preferable to use hydrogen concentration. This is because it affects the amount of hydrogen that enters the steel strip during the annealing process.

The gas composition of the atmosphere gas in each of the reheating zone 9, the overaging zone 10, and the final cooling zone 11 can be used as the operation parameters in the reheating section. It is particularly preferable to use hydrogen concentration. This is because it affects the easiness of escape of hydrogen in the steel to the outside in the reheating process.

Further, the concentration of gas component inside each section changes depending on the H₂, N₂, and H₂O supplied to the annealing section and the reheating section, thereby changing the internal dew point, that is, the H₂O concentration. Since this affects the concentration of H₂ in the atmosphere, the dew point inside the annealing section and the reheating section may be used as the operation parameters in the continuous annealing line.

### Selection of Operation Parameter of Continuous Annealing Line

In this embodiment, at least one of the operation parameters selected from the above operation parameters of the continuous annealing line is input to the prediction model of hydrogen content in steel of the steel strip.

The reason for using the operation parameters related to the thermal history of the steel strip in the annealing section and the reheating section is that the diffusion rate of hydrogen in steel is affected by the temperature of the steel strip. Further, when the diffusion rate of hydrogen is high, hydrogen tends to penetrate from the surface of the steel strip.

The reason for using the time the steel strip takes to pass through each zone (residence time in each zone) when it passes through the annealing section and the reheating section as the operation parameters is that they affect the amount of hydrogen that enters the steel or the amount of hydrogen that is discharged. Further, these amounts change during diffusion time in the steel.

The hydrogen content in steel increases in the annealing section where the steel strip is kept at a high temperature, and the hydrogen content in steel decreases in the reheating section where the steel strip is kept at a relatively low temperature. Therefore, it is preferable to use a combination of at least one parameter selected from the operation parameters of the annealing section and at least one parameter selected from the operation parameters of the reheating section as the operation parameters related to the thermal history. This is because the hydrogen content in steel of the steel strip detected at the delivery side of the continuous annealing line is greatly affected by the balance between the hydrogen entering the steel and the hydrogen being discharged from the steel.

On the other hand, the reason for using the operation parameters related to the atmosphere in each zone of the annealing section and the reheating section is that, as described above, the composition of the atmosphere gas affects the hydrogen entering the steel and the hydrogen being discharged from the steel. Therefore, it is preferable to use a combination of at least one parameter selected from the operation parameters related to the thermal history and those selected from the operation parameters related to the atmosphere gas in this embodiment. This is because they all affect the hydrogen entering the steel and the hydrogen being discharged from the steel.

With respect to the operation parameters in the continuous annealing line in this embodiment, one set of operation parameters is acquired as training data for each steel strip as the operation data. This is because information on the hydrogen content in steel, which is the output of the prediction model of hydrogen content in steel, is basically collected for each steel strip. In this case, the above-described data on thermal history and data on atmosphere gas and the like are continuously collected in the longitudinal direction of the steel strip, and a representative value is calculated for one steel strip and used as the operation parameter in the continuous annealing line. For example, it is possible to use data collected at a preset distance from the lead end or the tail end of the steel strip, or data obtained by averaging the measured values in the longitudinal direction.

### Transformation Rate Information

In this embodiment, the transformation rate meter 20, which measures the ratio of austenite phase, is installed in at least one of the annealing process or the reheating process of the continuous annealing line, and the result of measurement by the transformation rate meter 20 is used as transformation rate information as one of training data for the prediction model of hydrogen content in steel.

The data acquired by the transformation rate meter 20 is continuous data acquired at each sampling cycle in the longitudinal direction of the steel strip as data of the ratio of austenite phase of the steel strip, and a representative value is calculated for one steel strip and used as performance data of transformation rate information. It is preferable to use the measurement result of the transformation rate measured at a position roughly corresponding to the position where the performance data of the information on the hydrogen content in steel of the steel strip, which is the output of the prediction model of hydrogen content in steel, is acquired as the performance data of transformation rate information. In the continuous annealing line, the transformation rate of the steel strip may vary in the longitudinal direction, and the correlation between the transformation rate and the hydrogen content in steel of the steel strip is relatively high. Therefore, by associating the measured value of the transformation rate with the performance data collection position of the hydrogen content in steel, it is possible to predict the hydrogen content in steel with higher accuracy.

As used herein, the ratio of austenite phase (γ phase) of the steel strip is an important parameter for predicting the hydrogen content in steel. In general, the austenite phase has a hydrogen diffusion coefficient about one digit smaller than that of the ferrite phase (α phase). Therefore, in a zone such as the soaking section of the continuous annealing line, in which the temperature is high and γ-phase is the main phase, the penetration of hydrogen from the surrounding atmosphere gas into the steel is slowed down, and the hydrogen that has penetrated into the steel is less likely to be released to the surroundings. On the other hand, in a zone such as the overaging zone 10 where an internal microstructure with a certain amount of ferrite phase (α-phase) is formed, the penetration of hydrogen from the surrounding atmosphere gas into the steel is facilitated, and the hydrogen that has penetrated into the steel is likely to be released to the surroundings.

In the continuous annealing line, the mechanical properties of steel are controlled by controlling the microstructure of the steel strip using phase transformation, and the internal microstructure of the steel strip changes as the steel strip passes through each zone of the annealing section (heating zone 6, soaking zone 7, and cooling zone 8) and the reheating section (reheating zone 9, overaging zone 10, and final cooling zone 11). Therefore, acquiring information on the austenite phase (γ phase) of the steel strip by the transformation rate meter 20 improves the prediction accuracy of the hydrogen content in steel of the steel strip.

The phase transformation behavior of the steel strip varies depending on the strength level and the chemical composition of the steel strip as a product, and the history of changes in the internal microstructure also changes. Therefore, when trying to predict the hydrogen content in steel for different types of steel, the significance of using the transformation rate information acquired by the transformation rate meter 20, which reflects the information on the internal microstructure of the steel strip, in the prediction model of hydrogen content in steel increases.

On the other hand, the reason for using the transformation rate information measured by the transformation rate meter 20 in addition to the operation parameters of the continuous annealing line in this embodiment is as follows. The operation parameters of the continuous annealing line affect the hydrogen content in steel of the steel strip through processes such as recovery, recrystallization, grain growth, precipitation, and phase transformation in the internal microstructure of the steel strip. However, such changes in the internal microstructure are not only determined by the operation parameters of the continuous annealing line, but also are affected by the processing history of the preceding hot rolling and cold rolling processes. For example, the coiling temperature in the hot rolling process affects the size (distribution) and amount of precipitate as the internal microstructure of a hot-rolled steel sheet, and it also affects the grain growth and transformation behavior in the heat treatment process. The rolling reduction during the cold rolling process affects the recrystallization, grain growth, and transformation behavior of the annealing process through the strain state accumulated in the internal microstructure of a cold-rolled steel sheet. Therefore, if only the operation parameters of the continuous annealing line are used as training data for the prediction model of hydrogen content in steel, the influence of the operation parameters of processes preceding the annealing process on the hydrogen content in steel of the steel strip after heat treatment is not taken into consideration. As a result, it is difficult to predict the hydrogen content in steel.

On the other hand, by using the transformation rate information measured by the transformation rate meter 20 in the heating or reheating process as the training data, the influence of the operation parameters in the hot rolling process and the cold rolling process, which are processes before the annealing process, on the hydrogen content in steel of the steel strip after heat treatment can be taken into consideration as indirect information in the process in the continuous annealing line. As a result, it is possible to predict the hydrogen content in steel as a prediction model of hydrogen content in steel.

As described above, in this embodiment, the transformation rate meter 20, which measures the ratio of austenite phase, is installed in at least one of the annealing process or the reheating process of the continuous annealing line, and the result of measurement by the transformation rate meter 20 is used as transformation rate information as one of training data for the prediction model of hydrogen content in steel.

### Attribute Parameter Related to Chemical Composition of Steel Strip

In this embodiment, it is preferable to further have at least one parameter selected from the attribute parameters of the steel strip related to the chemical composition of the steel strip as data to be input to the prediction model of hydrogen content in steel. This is because the phase transformation behavior and the internal microstructure during the heat treatment process are affected by the chemical composition of the steel strip. Further, in this case, it is possible to acquire a prediction model of hydrogen content in steel that predicts the hydrogen content in steel of steel strips with various chemical compositions for cold-rolled steel sheets manufactured by the continuous annealing line, thereby expanding the scope of application of the prediction model of hydrogen content in steel.

Contents of C, Si, and Mn as chemical components contained in the steel strip can be used as the attribute parameters related to the chemical composition of the steel strip. The attribute parameters related to the chemical composition of the steel strip may also include contents of Cu, Ni, Cr, Mo, Nb, Ti, V, B, and Zr. However, it is not necessary to use all of these chemical components as attribute parameters related to the chemical composition of the steel strip. A part of these components may be appropriately selected according to the type of steel strip to be manufactured by the continuous annealing line.

C is an element effective in increasing the strength of a steel sheet, and it contributes to high strength by forming martensite, which is one of the hard phases in the steel microstructure.

Si is an element that contributes to high strength mainly through solid solution strengthening. The decrease in ductility is relatively small with respect to the increase in strength, so that it contributes not only to strength but also to an improvement in the balance between strength and ductility. On the other hand, Si tends to form Si-based oxides on the steel sheet surface, which stabilizes austenite during annealing, resulting in the formation of retained austenite in a final product.

Mn is an element effective in contributing to high strength through solid solution strengthening and martensite formation.

Nb, Ti, V, and Zr combine with C or N to form carbides or nitrides (or carbonitride in some cases) as fine precipitates, which contributes to high strength of a steel sheet.

Cu, Ni, Cr, Mo, and B are elements that contribute to high strength because they enhance the hardenability and facilitate the formation of martensite.

These chemical components have a substantially constant distribution in the longitudinal direction of a steel strip, and one attribute parameter can be acquired as performance data for one steel strip.

Further, in addition to the attribute parameters of the steel strip related to the chemical composition of the steel strip, attribute parameters related to the dimensions of the steel strip, such as the thickness, width, and length of the steel strip, may be used as training data of the prediction model of hydrogen content in steel in this embodiment. This is because they affect the heat transfer behavior in the continuous annealing line and thus affect the hydrogen content in steel of the steel strip due to different temperature changes in the steel sheet, even at the same furnace atmosphere temperature.

### Method of Controlling Hydrogen Content in Steel of Steel Strip

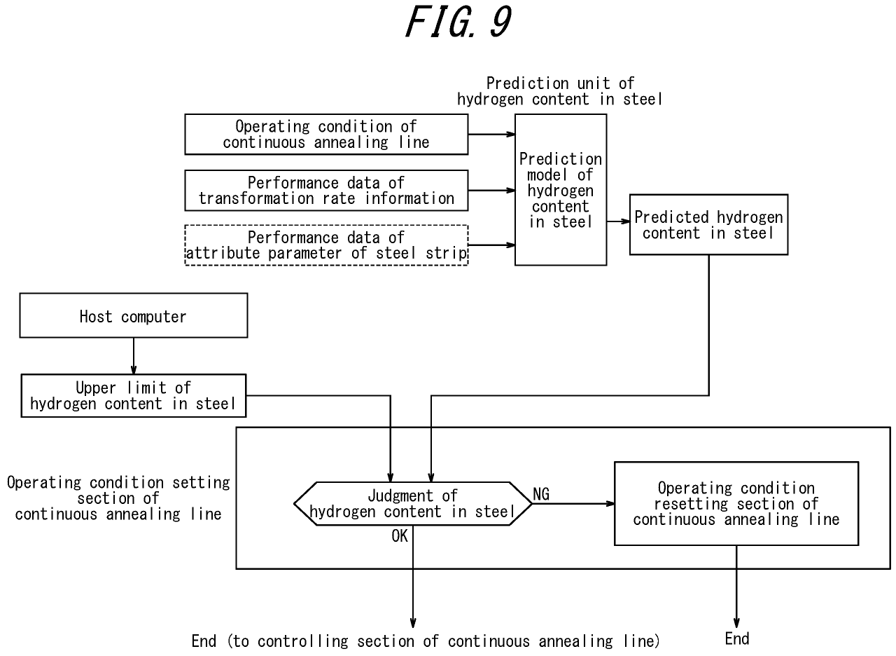

FIG. 9 illustrates a method of controlling hydrogen content in steel of a steel strip using the method of predicting hydrogen content in steel as described above.

A method of controlling hydrogen content in steel according to this embodiment differs depending on the installation position of the transformation rate meter 20 installed in at least one of the annealing process or the reheating process of the continuous annealing line. Specifically, when a plurality of transformation rate meters 20 are installed for transformation rate information to be input to the prediction model of hydrogen content in steel formed as described above, there are two zones of a zone on the upstream side of the transformation rate meter 20 installed on the most downstream side and a zone on the downstream side thereof. The zone from the entry side of the continuous annealing line to the transformation rate meter 20 is called an identification zone of hydrogen content in steel. The zone downstream of the transformation rate meter 20 is called a controlling zone of hydrogen content in steel. When the lead end of the steel strip to be subjected to prediction of hydrogen content in steel reaches the position of the transformation rate meter 20 and the transformation rate information of the steel strip is acquired, the control flow illustrated in FIG. 9 is started.

For the steel strip whose hydrogen content in steel is to be controlled, the operational performance data of the continuous annealing line acquired in the identification zone of hydrogen content in steel of the continuous annealing line and the transformation rate information measured by the transformation rate meter 20 are data to be input to the prediction model of hydrogen content in steel. The process of acquiring these input data may be referred to as input data acquisition. In the input data acquisition, the operational performance data of the continuous annealing line in the controlling zone of hydrogen content in steel at that time or the set values of the operating conditions of the continuous annealing line may be further acquired as data to be input to the prediction model of hydrogen content in steel. Using the data thus acquired as input data, the prediction model of hydrogen content in steel is used to predict the hydrogen content in steel of the steel strip on the downstream side of the reheating process.

On the other hand, in this embodiment, an upper limit of the hydrogen content in steel of the steel strip is further set in the host computer, and the predicted hydrogen content in steel is compared with the upper limit. With respect to steel materials to be used in environments where hydrogen embrittlement cracking may be a problem in practice, the upper limit of the hydrogen content in steel is preferably set as a value that is higher than the target value, to which the hydrogen content in steel of the steel strip is to be reduced, to the extent that problems do not occur in practice. For example, the upper limit of the hydrogen content in steel may be set as 0.30 ppm.

An operating condition setting section of the continuous annealing line compares the predicted hydrogen content in steel with the upper limit of the hydrogen content in steel that has been set as described above. If the predicted hydrogen content in steel is equal to or lower than the upper limit, the operating conditions of the continuous annealing line are determined as initially set and sent to the controlling section of the continuous annealing line. On the other hand, if the predicted hydrogen content in steel exceeds the upper limit, the operating conditions in the controlling zone of hydrogen content in steel are reset.

Specifically, when the most downstream transformation rate meter 20 in the continuous annealing line (meaning the one on the most downstream side among the transformation rate meters 20 that provide transformation rate information to be input to the prediction model of hydrogen content in steel) is installed at the outlet of the soaking zone 7 in the annealing process, the area from the entry side of the continuous annealing line to the outlet of the soaking zone 7 is the identification zone of hydrogen content in steel, and the downstream side of the outlet of the soaking zone 7 is the controlling zone of hydrogen content in steel. When the lead end of the steel strip reaches the outlet of the soaking zone 7 and the transformation rate information is acquired by the transformation rate meter 20, the flow of controlling the hydrogen content in steel illustrated in FIG. 9 is started. In the controlling zone of hydrogen content in steel, operating conditions selected from cooling conditions in the cooling zone 8 (first cooling zone 8A and second cooling zone 8B), reheating conditions in the reheating zone 9, holding temperature and holding time in the overaging zone 10, and cooling rate in the final cooling zone 11 can be reset as operating conditions that can be used to control the hydrogen content in steel. The operating conditions to be reset are not necessarily limited to those to be input to the prediction model of hydrogen content in steel.

On the other hand, when the most downstream transformation rate meter 20 is installed at the inlet or outlet of the reheating zone 9, the controlling zone of hydrogen content in steel is limited to an area after the overaging zone 10 or the final cooling zone 11. Therefore, the operating conditions to be reset in the continuous annealing line are limited to the holding time in the overaging zone 10, the mixing ratio of the atmosphere gas components of the overaging zone 10, the cooling rate of the final cooling zone 11, and the like.

Therefore, the position of the most downstream transformation rate meter 20 for the input of the prediction model of hydrogen content in steel may be appropriately determined based on the balance between the degree of freedom of the operating conditions to be reset and the prediction accuracy of the prediction model of hydrogen content in steel. In other words, increasing the length of the identification zone of hydrogen content in steel improves the prediction accuracy of hydrogen content in steel, but it reduces the degree of freedom of operating conditions that can be reset in the controlling zone of hydrogen content in steel. In contrast, decreasing the length of the identification zone of hydrogen content in steel reduces the prediction accuracy of hydrogen content in steel, but it improves the degree of freedom of operating conditions that can be reset in the controlling zone of hydrogen content in steel.

A steel strip having an internal microstructure mainly composed of γ phase is less likely to release the hydrogen in steel, and hydrogen is likely to be released as the ratio of α phase increases. Therefore, it is preferable to set the controlling zone of hydrogen content in steel downstream of the cooling zone 8 in the annealing section to effectively reduce the hydrogen content in steel. As described above, when a plurality of transformation rate meters 20 are installed in the continuous annealing line, it is preferable to separate the identification zone of hydrogen content in steel and the controlling zone of hydrogen content in steel with the transformation rate meter 20 on the most downstream side as a reference. However, the transformation rate meter 20 for separating the identification zone of hydrogen content in steel and the controlling zone of hydrogen content in steel does not necessarily have to be the transformation rate meter 20 on the most downstream side. The identification zone of hydrogen content in steel and the controlling zone of hydrogen content in steel may be separated with any transformation rate meter selected from the plurality of transformation rate meters 20 as a reference.

### Device that Predicts Hydrogen Content in Steel

The configuration of a device that predicts hydrogen content in steel is the same as that of the first embodiment (see FIG. 5). Note that the “continuous galvanizing line” used in the description of the device that predicts hydrogen content in steel according to the first embodiment shall be read as “continuous annealing line”.

### Example of Second Embodiment

The following describes this embodiment in detail with reference to examples.

In the continuous annealing line illustrated in FIG. 6, 200 coils of cold-rolled steel sheet (where the upper limit of hydrogen content in steel was 0.30 ppm) were manufactured. The performance data of the attribute information of a steel sheet to be charged into the continuous annealing line and the operational performance data of the operation parameters in the continuous annealing line were used as input performance data, and the hydrogen content in steel of the steel sheet at the delivery side of the continuous annealing line using the input performance data was used as output performance data, to acquire a plurality of training data. Through machine learning using the plurality of training data acquired, a prediction model of hydrogen content in steel was formed with the method illustrated in FIG. 8, where information on the hydrogen content in steel of a steel strip downstream of the reheating process was used as output data.

During the formation of the prediction model of hydrogen content in steel, C, Si, and Mn contents were used as attribute parameters of the steel strip related to the chemical composition of the steel strip to be input. Further, the temperature of the steel sheet in the soaking zone 7 and the transport speed at which the lead end of the steel strip passed through the soaking zone 7 were input as operational performance data of the continuous annealing line. In this embodiment, on-line transformation rate meters 20 were installed at two positions of the outlet of the soaking zone 7 and the inlet of the overaging zone 10 of the continuous annealing line illustrated in FIG. 6, and the performance data of transformation rate information measured by these transformation rate meters were used as input performance data.

Further, in this embodiment, the set values of the thickness and width of the steel strip were used as other inputs to form a prediction model of hydrogen content.

Here, the hydrogen content in steel of the steel strip acquired as training data was the hydrogen content in steel acquired with a temperature rise hydrogen analysis method by gas chromatograph, where a test piece was collected after the strip had passed through the continuous annealing line.

The prediction model of hydrogen content in steel thus formed was applied to a prediction unit of hydrogen content in steel for controlling hydrogen content in steel as illustrated in FIGS. 9, and 100 coils of cold-rolled steel sheet were manufactured. In other words, a method of predicting hydrogen content in steel of a steel strip using the prediction model of hydrogen content in steel was applied to a method of controlling hydrogen content in steel of a steel strip and a manufacturing method.

The hydrogen content in steel of the steel sheet at the delivery side of the continuous annealing line was predicted using the prediction model of hydrogen content in steel, and the operation parameters of the continuous annealing line were reset so that the predicted hydrogen content in steel would be equal to or lower than a preset upper limit (in this case, it was set at 0.30 ppm). Since the most downstream transformation rate meter 20 was installed at the inlet of the overaging zone 10, the area from the entry side of the continuous annealing line to the inlet of the overaging zone 10 was the identification zone of hydrogen content in steel, and the area downstream of the inlet of the overaging zone 10 was the controlling zone of hydrogen content in steel. The flow illustrated in FIG. 9 was started after the lead end of the steel strip reached the inlet of the overaging zone 10. In the controlling zone of hydrogen content in steel, the holding temperature and holding time in the overaging zone 10 and the cooling rate in the cooling zone 8 were reset as operating conditions to be used to control the hydrogen content in steel. After that, the hydrogen content in steel of these steel strips acquired by the hydrogen content in steel measurement test were collected.

As a result, 98% of the steel strips had a hydrogen content in steel equal to or lower than the upper limit (0.30 ppm).

On the other hand, a continuous annealing line not equipped with the above-described prediction unit of hydrogen content in steel was operated without resetting the operating conditions of the continuous annealing line as a comparative example. As a result, 75% of the steel strips had a hydrogen content in steel equal to or lower than the upper limit.

As described above, direct prediction is performed using the above-described machine learning model with the method of predicting hydrogen content in steel according to this disclosure. As a result, the hydrogen content in steel of a steel strip can be predicted with high accuracy, and the hydrogen content in steel can be effectively reduced.

### REFERENCE SIGNS LIST

1 payoff reel
2 welder
3 electrolytic cleaning device
4 entry-side looper
5 preheating zone
6 heating zone
7 soaking zone
8 cooling zone
8A first cooling zone
8B second cooling zone
9 reheating zone
10 overaging zone
11 final cooling zone
11A first final cooling zone
11B second final cooling zone
12 delivery-side looper
13 temper rolling system
14 inspection system
15 tension reel
16 galvanizing tank
17 alloying zone
18 holding zone
19 snout
20 transformation rate meter
21 wiping device
22 sink roll

1. A method of predicting hydrogen content in steel of a steel strip, which is
in a continuous galvanizing line that performs manufacturing processes including an annealing process, a coating process, and a reheating process of a steel strip, a method of predicting hydrogen content in steel of a steel strip downstream of the reheating process, comprising
acquiring at least one parameter selected from operation parameters of the continuous galvanizing line and transformation rate information measured in at least one of the annealing process and the reheating process as input data, and
predicting hydrogen content in steel of a steel strip downstream of the reheating process using a prediction model of hydrogen content in steel that has been trained by machine learning and that outputs information on hydrogen content in steel of a steel strip downstream of the reheating process as output data.

2. The method of predicting hydrogen content in steel of a steel strip according to claim 1, wherein, when acquiring the input data, at least one parameter selected from attribute parameters of a steel strip related to a chemical composition of a steel strip is further acquired as the input data.

3. A method of controlling hydrogen content in steel of a steel strip, comprising predicting hydrogen content in steel of a steel strip downstream of the reheating process using the method of predicting hydrogen content in steel of a steel strip according to claim 1, and, when a predicted hydrogen content in steel exceeds a preset upper limit, resetting at least one operation parameter selected from operation parameters of the continuous galvanizing line so that hydrogen content in steel is equal to or lower than the upper limit.

4. A method of manufacturing a steel strip, which is
a method of manufacturing a steel strip in a continuous galvanizing line that performs manufacturing processes including an annealing process, a coating process, and a reheating process of a steel strip, comprising
acquiring at least one parameter selected from operation parameters of the continuous galvanizing line and transformation rate information measured in at least one of the annealing process and the reheating process as input data,
predicting hydrogen content in steel of a steel strip downstream of the reheating process using a prediction model of hydrogen content in steel that has been trained by machine learning and that outputs information on hydrogen content in steel of a steel strip downstream of the reheating process as output data, and
when a predicted hydrogen content in steel exceeds a preset upper limit, resetting at least one operation parameter selected from operation parameters of the continuous galvanizing line so that hydrogen content in steel is equal to or lower than the upper limit.

5. A method of forming a prediction model of hydrogen content in steel of a steel strip, which is
in a continuous galvanizing line that performs manufacturing processes including an annealing process, a coating process, and a reheating process of a steel strip, a method of forming a prediction model of hydrogen content in steel of a steel strip that predicts hydrogen content in steel of a steel strip downstream of the reheating process, comprising
at least acquiring at least one operational performance data selected from operational performance data of the continuous galvanizing line and performance data of transformation rate information measured in at least one of the annealing process and the reheating process as input performance data,
acquiring a plurality of training data, in which information on hydrogen content in steel of a steel strip downstream of the reheating process based on the input performance data is used as output performance data, and
forming a prediction model of hydrogen content in steel of a steel strip by machine learning using the acquired plurality of training data.

6. The method of forming a prediction model of hydrogen content in steel of a steel strip according to claim 5, wherein a technique selected from neural network, decision tree learning, random forest, and support vector regression is used in the machine learning.

7. A device that predicts hydrogen content in steel of a steel strip, which is
in a continuous galvanizing line that performs manufacturing processes including an annealing process, a coating process, and a reheating process of a steel strip, a device that predicts hydrogen content in steel that predicts hydrogen content in steel of a steel strip downstream of the reheating process, comprising
an acquisition unit that acquires at least one parameter selected from operation parameters of the continuous galvanizing line and transformation rate information measured in at least one of the annealing process and the reheating process, and
a prediction unit that predicts hydrogen content in steel of a steel strip downstream of the reheating process using a prediction model of hydrogen content in steel that has been trained by machine learning and that outputs information on hydrogen content in steel of a steel strip downstream of the reheating process as output data.

8. The device that predicts hydrogen content in steel of a steel strip according to claim 7, further comprising
a terminal device having an input unit for acquiring input information based on a user's operation, and a display unit for displaying a hydrogen content in steel predicted by the prediction unit, wherein
the acquisition unit updates some or all of operation parameters of the continuous galvanizing line based on the input information acquired from the input unit, and
the display unit displays the hydrogen content in steel predicted by the prediction unit using the updated operation parameters.

9-16. (canceled)
